(19) United States
(12) Patent Application Publication
(10) Pub. No.: US 2025/0137778 A1
(43) Pub. Date: May 1, 2025

(54) AUTOMATIC CALIBRATION FOR SUBTRACTIVE FABRICATION MACHINES

(71) Applicant: Patrick Baudisch, Berlin (DE)

(72) Inventors: Patrick Markus Baudisch, Berlin (DE); Martin Justus Taraz, Potsdam (DE); Shohei Katakura, Berlin (DE); Paul Methfessel, Potsdam (DE); Paul Brachmann, Berlin (DE); Robert Kovacs, Berlin (DE); Antonius Naumann, Potsdam (DE); Robin Wersich, Potsdam (DE); Jonathan Grenba, Berlin (DE); Lukas Budach, Potsdam (DE)

(21) Appl. No.: 18/835,622

(22) PCT Filed: Feb. 2, 2023
(86) PCT No.: PCT/US2023/012244

§ 371 Date: Aug. 2, 2024

Related U.S. Application Data
(60) Provisional application No. 63/306,035, filed on Feb. 2, 2022.
(60) Provisional application No. 63/362,657, filed on Apr. 7, 2022.

(51) Int. Cl. G01B 21/00; G05B 19/401

(52) U.S. Cl. CPC G01B 21/00; G05B 19/401; G05B 2219/33034

(57) ABSTRACT

An apparatus comprising a subtractive fabrication machine configurable to operate on a workpiece; and a sensor that detects changes in a workpiece in response to the subtractive fabrication machine operating on the workpiece.

### 1 RELATED APPLICATIONS

This application is a Patent Cooperation Treaty (PC) International Application claiming the benefit of U.S. provisional patent application Ser. No. 63/306,035 filed on Feb. 2, 2022 and U.S. provisional patent application Ser. No. 63/362,657 filed Apr. 7, 2022, which are incorporated by reference herein in their entirety.

### 2 INTRODUCTION

The present invention enables subtractive fabrication machines, such as laser cutters milling machines, water jet cutters, knife-based cutters, etc. to calibrate “themselves”, i.e., to determine certain parameters the device needs to know in order to produce precise, high-quality results and to apply these parameters.

Embodiments include an integrated subtractive fabrication device, such as a laser cutter, that produce high-quality results while requiring little or no user interaction apart from sending a model. Resembling the user experience of a (kitchen) appliance (“an instrument or device designed for a particular use or function” [https://en.wikipedia.org/wiki/Home_appliance] we sometime refer to these embodiments as laser cutter appliances. This makes the present invention easier to maintain, thus also allowing operation/maintenance without an expert technician, but by non-experts, such as teachers, students, librarians, etc.

The presented appliance achieves like so: (1) The device contains sensors. They sense various aspects that may impact the quality of the fabrication, such as relevant aspects of the current state of the device, the material located in the device, and/or the effect of the device onto the material. (2) The device operates the necessary sensors, e.g., while test cutting the material. (3) The device automatically applies the results of these measurements to itself and/or the model it receives for fabrication. (4) To allow for a wider range of such factors to be applied (in a self-contained matter, i.e., without having to delegate back to the application program), the device may optionally receive the model to be fabricated in a file format that allows a wider range of adjustments to be made.

Laser cutters are fabrication machines that allow processing physical materials, such as cutting and/or engraving them. Work pieces tend to include sheets of material. Materials tend to include wood, plywood, particleboard, acrylic, etc. and in some cases a wider range of materials, such as metal.

In order to produce precise and thus useful output, laser cutters (and to a certain extent other subtractive fabrication machines) require precise calibration, i.e., several parameters either have be entered/loaded into the machine or the model sent to the machine for cutting or engraving has to be adjusted accordingly. The list of such parameters includes (1) how wide a line of material the laser removes when cutting a line (aka kerf), (2) how thick the material actually is. (3) size and shape of the material to be cut from, (4) the number-of-passes, power, and speed (e.g., as the number-of-passes×power/speed=energy per length of cut or engraving, in the interest of brevity we will sometimes “power” for short) required to engrave a certain depth when raster engraving, to darken the material when raster engraving, when line engraving, to cut material to a certain depth, to cut through a subset of layers of a given sandwich material, and so on. Parameters tend to depend on the machine and the material at hand and they also tend to vary over time, e.g., as the laser source and/or the optical components are subjected to wear. But, most of all, these values depend on the material at hand.

As a consequence, some process that determines these parameters (the “calibration process”) may have to be repeated from time to time-often on a per-job basis.

Different users may have their respective take on calibration process ranging from satisficing with reusing previous settings and hoping that they continue to apply (despite changes in wear, potentially changes in material, etc.), guessing settings, a series of trail-and-error, to the use of calibration aids, such as by fabricating simple dedicated models that allow reading one or multiple of the desired settings.

This process, however, not only tends to consume material and time, thus creating cost, but may also prevent non-experts from operating such machines in the first place. Out of the typical fabrication process (modeling & export to cutter, setup & calibration, fabrication, assembly) set-up & calibration can easily become the most time-consuming part: As all other steps have experienced substantial speed-ups in recent years: modeling, by means of special-purpose modeling systems, such as flatFitFab [McCrae et al. 2014. FlatFitFab. In Proc. UIST '14], kyub [Baudisch, P. WO2018017626 SYSTEM AND METHOD FOR EDITING 3D MODELS] [Baudisch et al. Kyub. In Proc. CHI '19. 556,1-12]), cutting has essentially always been fast, and assembly by means of assembly-friendly layouts, such as roadkill [Abdullah et al. Roadkill: Nesting Laser-Cut Objects for Fast Assembly. In Proc. UIST '21, 972-984]). Set-up/calibration, in contrast, has largely been ignored so far, easily making it the bottle neck in this process.

Arguably even more important, calibration is not only time-consuming, but requires expertise. This either consumes substantial money for an expert technician (the salary of whom commonly vastly exceeds the cost of the actual machinery) or/and simply excludes non-experts from using these types of machinery.

This present invention aims at overcoming this hurdle. It makes laser cutters and similar machines easier to maintain, thus allows operating these machines without the help of an expert technician. This has the potential to making the field of subtractive fabrication accessible to non-experts, such as teachers, students, librarians, and for home use etc.

### 3 BACKGROUND

While many manufacturers offer only very limited help calibrating their machines, some manufacturer, such as Glowforge ([glowforge.com], [Shapiro et al. Moving Material During Laser Fabrication. U.S. Pat. No. 10,496,070]) and so a much lesser extent others, such as Trotec and Epilog) have added additional hardware to their machines, such as (1) one or more cameras facing downwards from the top of the casing, facing downwards from the laser head, or both. (2) These machines may thus be capable of recognizing the material placed into the cutter by equipping materials with a bar code that can be read using the/one of the camera(s) to then look up of its material properties from a database. (3) That same camera may also allow users to obtain a photograph of the material located in the cutter, e.g., to allow users to position the geometry to be cut on it.

Furthermore, some manufacturers, such as the ones listed above, have made attempts to reduce the necessity for calibration by limiting their ecosystems to standardized elements. (4) Their software may, for example, be running only on a certain type or a small number of types of proprietary machines. By knowing additional specifics about these machines, such as the type of laser source it employs, there is less to calibrate. (5) They may use materials that are particularly planar and of homogeneous hardness (commonly MDF, thinly coated with vernier, as well as other man-made materials, such as acrylic, etc.). (6) Models in the Glowforge universe are largely limited to models not containing press-fit joints (thus largely to 2D models) thereby bypassing the difficulties revolving around press-fits, such as kerf, fit, and repeatability (see below).

Finally. (since the methods discussed above are not quite sufficient to produce high-quality calibration) some manufacturers discourage or try to eliminate design elements that require a precise calibration. (6) When cutting 3D models, i.e., models that can be assembled from multiple parts, these manufacturers may encourage the use of cantilever snap-fit joints (e.g., building on [Thijs Roumen, et al. 2019. SpringFit: Joints and Mounts that Fabricate on Any Laser Cutter. In Proc. UIST '19. 727-738]), which are more tolerant to variations in the amount of material removed by the cutter (aka kerf) than the press-fit box joints used normally.

In the world of research, an exploration has started aiming to produce sensors that allow automating a few isolated sensing activities involved in laser cutters: Sensicut [Mustafa Doga Dogan et al. 2021. SensiCut. In Proc. UIST '21. 24-38], for example, automatically classifies materials located inside the cutter. PacCAM [Daniel Saakes et al. 2013. PacCAM. In Proc. UIST '13. 441-446] and Packaide [Ticha Sethapakdi et al. 2021. In Proc. CHI '21. 1-12] (semi-) automatic distribute parts to be cut across a sheet of material (aka nesting).

While this is a promising start, there still is no automation for the vast majority of sensor activities required for end-to-end calibration (see list above). Furthermore, obtaining sensor readings is not enough-sensor readings also need to be applied, i.e., the settings of laser cutters etc. have to be adjusted and/or models need to be adjusted. We tackle both with the present invention.

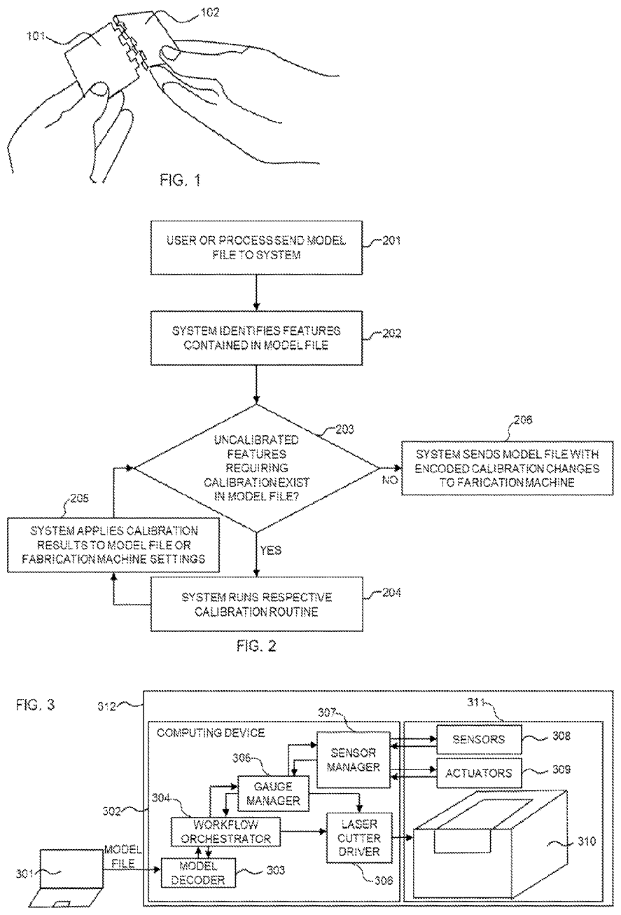

At the lowest level, subtractive (and other) fabrication machines tend to be operated using a machine-specific file format called GCODE, i.e., a file that contains instructions which actuator in the device to operate using which parameters and in what order [International Organization for Standardization, ISO 6983-1:2009]. In the case of a (2- or 3-axis) laser cutters, the parts to be cut largely form a 2D tool path, which allowed them to also be expressed in the form of a 2D drawing, which can be encoded, for example, in the Scalable Vector Graphics (SVG) file format [W3C. 2001. Scalable Vector Graphics], which can then automatically be converted to GCODE. While SVG, at first glance, appears to be machine-independent, it is not, as it does not allow representing kerf, limiting its portability when it comes to models containing press fit mechanisms, such as the two halves 101 and 102 forming a box joint to be assembled in the 3D shape on an angle (as illustrated by FIG. 1).

One approach to overcoming the kerf-dependence of SVG is to eliminate all model elements that form a press fit (springFit) and to replace bearings with kerf-invariant bearings (kerf-canceling mechanisms [Thijs Roumen, et al. Kerf-Canceling Mechanisms. In Proc. UIST '20, 293-303]). Another approach to overcoming the kerf-dependence of SVG is to use a file format that allows adjusting kerf after the fact (LaserSVG (Florian Heller, 2022, LaserSVG, https://github.com/florianheller/lasersvg) and metaSVG [Nur Yildirim, et al. MetaSVG: A Portable Exchange Format for Adaptable Laser Cutting Plans. In Proc. Graphics Interface 2022]. However, the specific way in which they handle the geometry adjustments require either detailed knowledge about the specific joint types and their behavior or cannot reproduce the modeled joint geometry in detail. We overcome this in the present invention.

In the context of 3D printing, McGatha [Jesse McGatha, et al. 2014. 3D printing method and computing device using arbitrary printers and arbitrary software applications (WO 2014/210394 A1)] envisioned a system capable of abstracting the details of 3D printers behind an operating system level layer. Laser cutting faces some similar challenges, such as how to monitor and account for wear, as well as some additional challenges, such as how to determine and calibrate for non-standardized materials.

As mentioned above, one of the aspects that make laser cutting complex is the fact that not just the laser cutter has to be considered, but also the material. Materials add a lot of complexity, as the material used in laser cutting commonly contain not only a number of material types (acrylic vs. plywood vs. MDF, etc.) but also a variety of sizes, aspect ratios, as well es cutouts, when material is re-used from previous projects. In addition, material not only comes in different thicknesses and numbers of layers, but also varies in the actual thickness (“4 mm” plywood commonly is only 3.8 mm thick) and may contain a wide range of glues between layers, as well as knotholes (even in the invisible middle layer). This makes laser cutting different from print (and Glowforge ecosystem), where materials tend to be standardized to a small number of formats.

Several laser cutter manufacturers (such as Trotec's Job control [https://www.troteclaser.com/en/laser-machines/jobcontrol], Universal laser's Control Panel [https://www.ulsinc.com/discover-uls-innovations/laser-system-user-interfaces]) tackle the issue by offering lists that map material classes to the power/speed settings suggested to cut these. This approach is of course a vast oversimplification, as it considers neither the actual laser cutter at hand (wear of the laser tube, the lens, etc.) nor of the actual material at hand (actual thickness, glue used, and so on).

Thus, ultimately, cutter and material need to considered on the actual cutter and with the actual material-which is what users do today, when they cut a simple calibration aid (aka “kerf strip”) from the material they are about to use on the machine they are about to use. This, of course, is a major time commitment, which is why we demonstrate how to automate this process in this invention.

### 4 Alternative Embodiments

Throughout this disclosure, we largely use the term “laser cutter” when speaking about the machine to calibrate. We are doing so in the interest of simplicity and readability. Nonetheless, even when we write “laser cutter” we generally refer to any machine out of a broader set of fabrication machines, including laser cutters, milling machines, water jet cutters, knife-based cutters, etc.

While we at times refer to a specific fabrication device (e.g., Trotec Speedy 360), sometimes with an associated API (e.g., Trotec Ruby) the present invention applies to any subtractive fabrication device by any manufacturer (such as, just to use laser cutters once more as example, devices by Epilog, Universal, Trumpf, Mr Beum, Glowforge, Aeon, Snapmaker, etc., as well as the wide range of cutters produced, for example, by Chinese manufacturers, etc.) and their APIs.

While we at times refer to a specific piece of application software (or application subsystem), such as kyub, the present invention applies to any such system (such as, FlatFitFab [McCrae et al. In Proc. UIST '14, 13-22], the suite of programs created by Autodesk, such as AutoCAD, Fusion360, TinkerCAD, etc.), as well as any of a wide range of open source or shareware tools, such as boxes.py, maker case, and so on.

We also often refer to “the material”, “the sheet”, or “the workpiece”, as if referring to single piece of piece, e.g., located in the laser cutter. However, the present invention generally equally applies to situations where multiple such pieces are being handled. In which this case, the respective embodiments simply (1) detect the presence of multiple pieces (e.g., using a camera performing segmentation and a “connected components” algorithm) and then (2) perform the respective process on each detected work piece.

While we at times make reference to a laser cutter with a horizontal cutting bed that one (or more) work pieces are being placed onto, staying in place based on gravity or suction of the ventilation system, different embodiments may employ different form factors, including devices the cutting bed of which is not horizontal, devices that hold the work piece is place using various fixtures, devices featuring pass-through mechanisms, or that actuate the work piece by means of (one or more) automated material feeders, material cartridges, robotic arms, lathe-like rotary setups, as well as devices offering fewer or more than 3 degrees of freedom.

The computing device interpreting the contents of this model may be contained in the same enclosure as fabrication device or may be connected to it.

Some elements disclosed in this document teach adding additional hardware to the head of a laser cutter. These additional elements should generally be designed for minimal mass, so as to keep the interference with the actuation of the laser head (such as a gantry, pantograph mechanism, robot arm, etc.) to a minimum. Someone skilled in the art will know that they can easily be achieved by replacing large motors with small motors with appropriate (in some cases back-driveable, low slack) transmissions, such as gear boxes, etc. At the same time, the actuation mechanism should be adjusted to properly deal with the additional load.

The fabrication device, aka the laser cutter, may be physically connected any of the following but not limited to: a direct cable connection, a network, a wireless network, a physical data storage device, such as a USB stick or similar, a mobile print

Instead of transmitting to a laser cutter subsystem, could also save output, such as cutplan, to a storage medium such as a disk, SSD, memory stick, network drive, cloud storage, etc.

Instead of running on a general-purpose computing hardware, such as an IBM compatible personal computer (built into a laser cutter or separate from it), the software described in this disclosure may be run on a micro controller, a mobile device, etc.

### 5 DETAILED DESCRIPTION

In contrast, the present invention is designed to tackle the calibration challenge without limiting the eco system and without eliminating design elements. In particular, the present invention aims to allow (1) working with arbitrary materials on (2) arbitrary laser cutters with arbitrary wear while (3) still allowing users to use calibration-sensitive design elements.

In addition, (4) we tackle several additional features, such as calibration of cutting power, true material thickness, engraving depth, etc. (5) We automate all these.

And finally, (6) we integrate this process. In particular, we propose an integrated laser cutter device capable of performing the necessary calibration steps in a way transparent to the user, thereby allowing non-expert users, i.e., users without calibration experience to produce well-fabricated objects. A key element to achieving this is a file format and process that allows the device to do so.

In one possible embodiment, i.e., an integrated system consisting of an application talking to the present invention subsystem (we will sometimes refer to this embodiment as a laser cutter appliance) a user session may go like this: (a) The user has created or loaded a model into a design application for laser cutting (such as kyub). (b) The user triggers the export of the model to the laser cutter. (c) Here the user also picks a laser cutter and one or more material sheets to use—this, however, is optional at this point in time. (c) The design application now converts the 3D model into a 2D format (as disclosed in [WO2019075278—SYSTEM AND METHOD FOR HANDLING ASSETS FOR FABRICATION]). It then invokes an encoder that is part of the present invention; it encodes the 2D plates as well as additional information extracted from the original 3D format into the resulting file; this additional information will allow making additional adjustments to the file later on. In the remainder of this disclosure we refer to the format as a cutplan (and tend to identify files by giving them the extension “.cut”). The user picks a cutter to send the file to. (d) The user inserts one or more sheets of material and, either triggered by the using pressing some “start” button or triggered by closing the device, the laser cutter starts. (e) It now extracts what features are contained in the model that may require calibration and performs its calibration routine accordingly. (f) It then, typically without further user interaction, fabricates the parts for the model, (g) which the user removes from the cutter and assembles. As a result of the calibration, the parts and the assembled model are of high quality.

This system may be operated in various orders. While the above use case started with the model, usage may also start without the model: (1) The user (or some mechanism) places (one or more pieces of) material into the cutter. (2) The system locates the material pieces, e.g., using a camera. (3) In order to speed things up later, the system may now already perform a range of calibration steps on this material, i.e., if the system deems calibration necessary, it performs the respective calibration routine on one or multiple of the material pieces in the cutter. (5) When the user now sends one or more models to the laser cutter, e.g., from a repository or from a modeling software, such as Kyub, of FlatFitFab, or AutoCAD, slicer, etc. (6) the system positions the parts of the model onto the material pieces (aka nesting) and (7) cuts/engraves the model. (8) When done, the user (or some automated mechanism) removes the parts from the laser cutter and, if necessary, assembles the model.

Note that different models require different subsets of parameters to be calibrated. Information about required parameters may be included in the model file, handed down by the modeling software, or inferred by the present invention. Only if a model encompasses, for example, engravings, then the system may want to invoke the respective calibration routine. Users may thus prevent the system from calibrating until the model has been received send the (e.g., by configuring the system so as to wait for the model(s) or my simply sending the model(s) before placing material in the cutter), as this allows the present invention to limit calibration to the routines actually required by the model(s) to be fabricated.

FIG. 2 shows the process on simplified, abstract level (i.e., without the system architecture that makes this process usable and maintainable). The user or some process 201 submits a model for fabrication in the form of a model file to the proposed system (e.g., which may be part of a laser cutter or similar fabrication machine, or it may be a separate machine or process). The system now analyzes the model file and identifies what 202 types of features it contains that 203 may require calibration. 204 The system runs specific calibration routines for each of the features that may require calibration and 205 applies the result to the settings of the laser cutter and/or the model file. Upon completion, 206 the system sends the resulting model file with the applied calibration changes to the actual laser cutter.

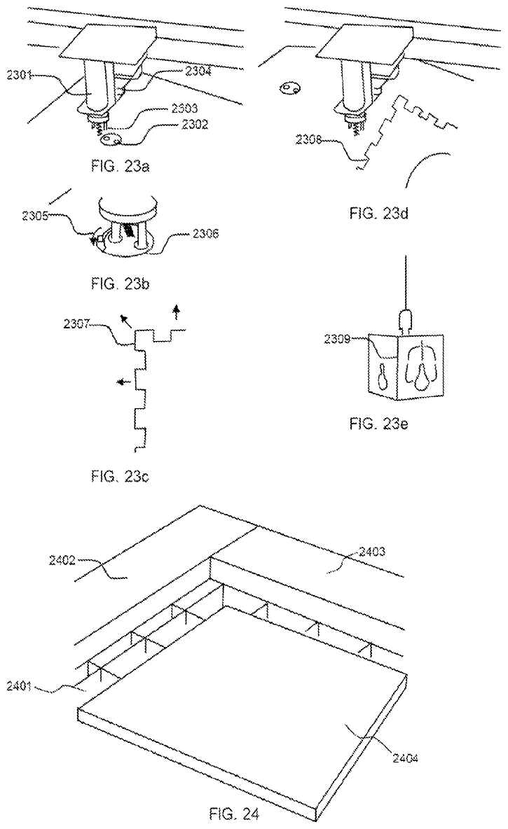

FIG. 23 takes a closer look at what happens in this process (albeit here illustrated with just a single calibration tool, which will refer to as a “gauge”, meaning “a device used to make measurements and to encode certain dimensional information”): (a) When the user sends a model to the laser cutter, our system intercepts the job and injects an automated calibration routine. This routine performs one or more calibration routines. An example of such a routine would be a routine that determines how much material the laser cutter removes during cutting, also known as kerf. For this purpose, we have attached additional hardware to the head of the laser cutter. The device, which we call Kerfmeter, starts by cutting what we call a spiral gauge, (b) inserts its pair of prongs into the spiral gauge, and rotates it until it jams. Kerfmeter reads the angle θ at which this takes place using an encoder. This angle indicates how much material the laser has removed, i.e., the laser's kerf. (c) Our system triggers the adjustment of the model, here the dilation by the amount of kerf determined in the previous step, and (d) proceeds to fabricate the model. (e) The calibration process assures that the resulting model achieves a high fabrication quality. In the shown example, the kerf-calibrated joints make the model loose enough to allow for comfortable assembly, yet also tight enough to resist tension, such as when suspending the model.

While the above figure shows the calibration of one specific aspect, namely kerf, objects may contain elements that require additional or different types of calibration. The process may thus cover the calibration of a different set of features, including, but not limited to cutting speed and power, number of passes, detection of burning or burn marks, engraving depth, intensity of marking, depth of partial cuts (e.g., for HingeCore [Muhammad Abdullah, et al. HingeCore: Laser-Cut Foamcore for Fast Assembly. In Proc. UIST '22. 10, 1-13]), and so on.

### 6 Sensors & Application to Settings/Models

A key benefit of the system design disclosed here is to allow for a (partially, largely, or fully) automated calibration process, which means to minimize the necessity for user interaction. We achieve this by (1) automating the measurement of calibration-relevant information, (2) applying these sensor readings to the settings of the laser cutter device and/or the model and, optionally (3) running independent of the user-facing application that generated the model. The latter, in the most consequent embodiment, means that it is running within the laser cutting device (while other “less-integrated” embodiments use a separate computer) allowing users to send or upload their model to the device in order to see it being fabricated automatically and in a well-calibrated manner.

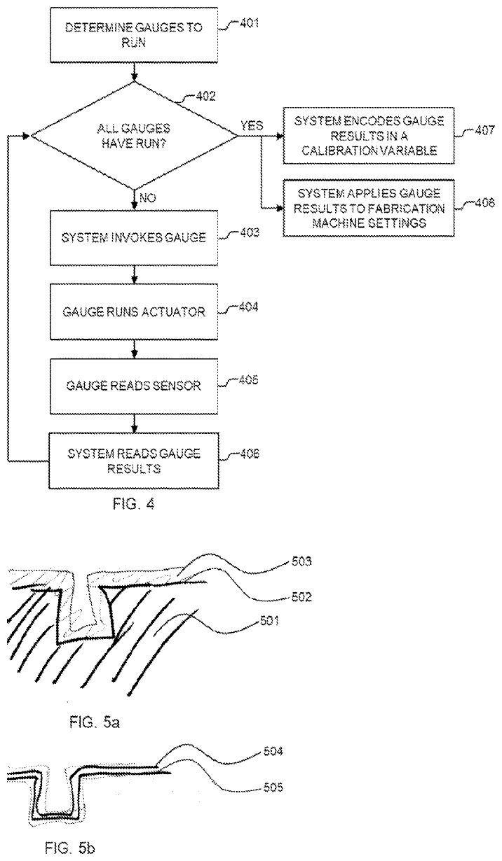

FIG. 3 shows one possible component architecture. On a computer 301, the user (or some other process) triggers the fabrication of a model. The computer is (by cable network, cloud, etc.) connected to what we will refer to as a laser cutter subsystem 312, consisting of some computing device 302 and one or more laser cutters 310; these may be separate devices or integrated into one. The computer encodes the model in a model file. The model may be encoded in a variety of formats, including file formats that allow adjusting the model geometry later, such as the cutplan format discussed below. The model decoder 303 now decodes the file, identifies which aspects of the model may require calibration and (optionally managed by a centralized workflow orchestrator 304), asks the gauge manager 305 to determine that calibration information. The gauge manager in turn runs the respective “gauges” which in turn ask the sensor manager 307 to run the respective sensors for them. It runs the respective actuators 309 and reads the respective sensors 308 and sends the resulting calibration information back the chain to the model decoder which integrates the calibration information into the model file and passes the result to the workflow orchestrator. Finally, the workflow orchestrator sends the model file to the laser cutter driver 306 which sends it to the laser cutter 310. We may refer to the entirety of sensors, actuators and laser cutter as 311 laser cutter appliance. The complete process is also shown in FIG. 4.

FIG. 4 zooms in on the process performed by the gauge manager. The gauge manager 401 starts by determining which features to calibrate. It may do so (a) “brute force”, by simply collecting and running all gauges available (such as, cutting outlines, engraving of a certain depth, and/or marking with a certain darkness . . . as listed earlier) or, (b) inspect a list of features handed down from the decoder and map that to its gauges, and then pick only the gauges that are necessary for calibrating for the model at hand. Finally, (c) the gauge manager may optionally also look up calibration values stored during previous runs, analyze whether these can still be expected to be “good enough” and if so, use the respective stored values, rather than running the respective gauges. Example: while the power of a laser tube does decrease over time, it does so slowly, thus a calibration of laser power might be reused for a while before determining it again.

After determining which gauges should be run, the gauge manager 402 runs all selected gauges by either invoking them directly or by 403 being invoked by another component of the laser cutter subsystem once the value calibration should be performed.

Each gauge contains information about (optionally, what actuator has to be run and how and) what sensor has to be read in order to calibrate its respective feature. This information can, for example, be encoded in the form of program code, similar to how “drivers” in common computer systems encode how to run peripherals. Example: for a model file containing the feature “line engraving”, the gauge manager would invoke the “line engraving gauge” which in turn would 404 start running an actuator specific to the gauge, in this case causing one or more short line engraving to be created in the actual material sheet currently located in the laser cutter. The gauge would 405 observe the result using one or more sensors and 406 as a result determine (some of) the mapping from cutting speed and power to the depth and darkness of the line engraving. The resulting calibration values are then applied 408 either to the settings of the laser cutter, 407 to the model or both. One possible mechanism for doing so is to store the calibration results in variables such “$thickness(0)”, as we discuss later in this disclosure.

To expand on how the result are to be applied: Ideally, all relevant features could be applied by writing some (global) laser cutter settings and some laser cutters support may support this for some features, such as a global cutting for cutting speed. Some features, however, are hard to express “globally” as they make reference to specific locations in the design to be cut. Compensating for kerf, for example, requires moving or deforming lines, which are geometric objects inside a 2D layout to be cut (aka cutting plan). The direction in which a line has to be moved in response to kerf, for example, depends on the local geometry of the model (lines tend to divide up space into a halfplane that forms a “part” and a halfplane that forms “scrap”; to express a larger kerf, lines need to be moved towards the scrap halfplane). It is thus difficult to achieve this using a global transformation. Features that make reference to such “local” features are therefore often better handled by updating the model. If that is not the case, the apply to model (407) in FIG. 4 can be skipped.

Finally, some values, could in theory be handled using (global) laser cutter setting, but the specific device at hand lacks that ability, i.e., does not expose this type of functionality. The mapping from brightness values in a bitmap to engraving depth, for example, may require calibration, as the user creating the bitmap might expect that mapping to be linear, when the result by the machine is not linear (meaning: sending a bitmap with one area of pixels representing a certain gray value and another area of pixels representing a gray value twice as dark may not produce an engraving that is twice as deep; also: some gray values may produce no visible engraving at all, and so on). Sending a bitmap with engraving information encoded as a bitmap may thus lack discernable detail in at least some brightness intervals. An ideal laser cutter would allow updating the way the device maps grayscale values to engraving power, e.g., by allowing users to create and upload such a map, e.g., in the form of a table, by sending a mathematical function, and so on, or by creating such a map automatically (see below). Other laser cutters, however, may lack such a feature. In this case, we may choose to handle a feature, here engraving depth, using the second route, i.e., to update contents in the model file in order to reflect the calibration information (e.g., applying an appropriate brightness adjustment to all bitmaps in the model intended to produce engravings). As discussed below, updating can be accomplished by reading or receiving a model, modifying up, and writing/sending the model; it can also mean to read a model containing variables and evaluating these in the context of the sensor readings.

Finally, we can still handle some spatial features using global settings. FIG. 5 shows a (piece of a) part 501 that we want to fabricate. Instead of storing the actual outline 502 in the model (which would be the idealized tool path assuming zero kerf), we store a line 503 in the model that is thicker that than the widest assumed kerf. Upon determining actual kerf a global function now replaces all thick lines 503 with pairs on actual lines 504 and 505, each of which offset from 503, so as to form a distance of kerf to the outline of 503. While this doubles the cutting effort (it cuts two lines instead of one) this kerf correction can now be achieved using a global replacement of lines without knowledge of which halfplane is part and which is scrap.

### 6.1 Software/Hardware Components

As a result, different embodiments require different subsets of software/hardware components. In the simplest case, there is:
(1) one or more “gauges”. Each gauge is a tiny subsystem as described above. Most actuators directly or indirectly affect the material located in the cutter. Sensors directly or indirectly (help control the actuators or) observe the effect of the actuators onto the workpiece. In order to do so, gauges connect to at least one sensor (which may be part of a standard laser cutter or custom) and optionally one or more actuators (which may be part of a standard laser cutter or custom). Laser cutters also tends to contain actuators (such as the gantry moving the laser head) and sensors (such as a camera, depending on model) allowing the laser itself to implement certain types of gauges (such as the cutting power gauge presented below) without requiring additional hardware. Gauges may use their own hardware or share hardware with other gauges.
(2) a gauge manager runs one or more gauges on the material(s) in the cutting space and reads the resulting values.
(3) a decoder/adjuster: applies the results on the calibration obtained through the gauges to the laser cutter settings, to the model, or both.

If the decoder/adjuster is to apply adjustments not just to (global) settings of the laser cutter, but also to geometric aspects of the model sent to the cutter, the system needs to use a file format that encodes models in an “adjustable” format (see the cutplan format we disclose below).

Different embodiments feature different subsets of sensors allowing them to handle different subsets of model features. Some embodiments may therefore opt for an extensible architecture that wraps hardware and software into a component or object, offering a unified API that allows easy integration of new hardware components or gauges.

Multiple gauges can now be managed in a single data structure using this style of gauge manager:

Running the gauges can now be accomplished by (registering all gauges and) calling the methods findRequirements, runRequiredGauges and adjustModel on the gaugeManager. While the individual gauges can each individually implement their decision process, they share access to the sensors and actuators over the gaugeContext. The gaugeManager provides this context to all gauges on registration.

### 6.2 Invocation

Different embodiments may invoke calibration based on different trigger events. Possible triggers include, but are not limited to:
(a) When a user has requested a model to be fabricated. The strength of this approach is that (1) there is a concrete model at hand, allowing the system to limit the calibration process to the dimensions that are required by the model at hand and (2) the user needs to place one or more sheets of material into the cutter anyways, allowing the calibration to take place on that material.
(b) When calibration information is outdated or on a fixed schedule. If there is no material present in the cutter, the system may request for material to be inserted. One particularly efficient approach is to use what we call a “patchwork” material sheet that is composed on multiple different material samples. This allows the system to perform its calibration procedure for multiple such samples in one go, without further user interaction. Patchwork material sheets can be created in a variety of ways including, joining (e.g., using jig saw puzzle joints etc.) or gluing samples or holding samples in a (disposable or reusable) frame.
(c) Upon user request, e.g., because the user has noticed calibration information being outdated. The use of specific calibration sheets of material, including various patchwork material sheets, are specific enough that they can also be used to trigger the calibration process, i.e., inserting such a sheet into the cutter featuring some material detection mechanism (camera recognizing the presence of a material sheets, pressure sensor or switch, laser barrier, detect material using a speckle sensor (e.g., SensiCut by MIT [Mustafa Doga Dogan, et al. In Proc. UIST '21, 24-38]), using a QR code reader for a QR code on the material sheets, etc.) may be used to trigger the calibration process.

As discussed earlier, some measurements made by gauges are best applied by storing them in the settings of the laser cutter itself or the settings associated with the current job, such as power and speed settings. Others, in contrast, make reference to elements of the model-thus applying those may require adjusting the model according to the gauge readings or at least (re) interpreting the model in the context of the gauge readings.

6.3 Alternative System Architectures: Application Vs. Laser Cutter Subsystem

Zooming the architecture shown in FIG. 3 all the way out, we see an “overall system” consisting of (1) the application subsystem that allows users to design (or at least select) models. This tends to be a user-facing application program. (2) the fabrication subsystem (aka laser cutter subsystem) that manages the fabrication machine, such as one or more laser cutters or similar machines, such as milling machines, water jet cutters, and so on.

Different embodiments may follow different strategies of where exactly to place the cut between the two subsystems.

The architecture shown in FIG. 3 aims to keep the two sub systems separated, only connected by an appropriate exchange format. This class of embodiments offers the benefit of simplified maintenance, i.e., the application subsystem may often be extended or updated without requiring the laser cutter subsystem to be updated as well. This is achieved by encapsulating everything that interacts with the laser cutter and the gauges in the laser cutter, eliminating the necessity for the laser cutter subsystem to ever contact the application subsystem. Alternative embodiments include: (a) the laser cutter subsystem processes only the sensors/gauges the result of which can be expressed by adjusting the settings of the laser cutter. Changes affecting the model, such as kerf are sent back to the application subsystem (which responds by sending an updated model), (b) the laser cutter subsystem also processes the sensors/gauges the result of which can be expressed by adjusting 2D aspects of the model, such as kerf

On a higher level, alternative embodiments may draw the line between application subsystem and laser cutter subsystem differently, such as:
(1) The “all-knowing” fabrication subsystem, i.e., the fabrication subsystem and the laser cutter subsystem are connected by a 3D exchange format up to the point where the file system is the 3D model that the design system uses, so that users export the 3d model by transferring a full 3D model to the laser cutter and (largely) the same 3D application is now also running on the laser cutter. The strength of this approach is that it allows making a very wide range of changes—conceptually even any change the application subsystem is capable of doing—but at fabrication time and thus with the knowledge available at fabrication time, such as the exact materials available and the calibration state of the machine. This approach even allows users to change the entire model at this time, e.g., in order to make optimal use of the available materials and/or to compensate for the calibration state of the machine. For maximum functionality, such overall systems may include a user-facing computing system with the laser cutter, such as a screen with pointing device and/or keyboard. Limitation is that this system is harder to maintain, as changes or new features in the application subsystem require the fabrication subsystem to be updated as well. This type of embodiment may send updated models back to the application subsystem

By enabling the laser cutter to do the 3D to 2D conversion, the laser cutter can operate entirely independently from the modeling software. While this allows users to share their model, it shifts the governance for adapting the model to changes in material to the laser cutter. This requires the laser cutter to adapt to changes on a volumetric level (e.g., by changes in the material thickness). Also, tasks like nesting that require user interaction would now be done at the laser cutter, a device we want to be an appliance rather than interacting with for high precision and fidelity tasks. Furthermore, it strips a designer of the authority to create a layout if this is to be redone by the laser cutter as part of the 3d to 2d conversion.
(2) Single integrated system is a variation of the smart fabrication subsystem described above, with the extension that the fabrication subsystem now even has access privileges to the application subsystem, allowing it to write modifications back to the application subsystem, retrieve additional models, etc.
(3) The “dumb” fabrication subsystem: in this class of embodiments, the user-facing application knows about the and potentially multiple or many laser cutters. Historical examples of this approach are low-cost laser printers from the early days of laser printing that, in order to save cost, contained very little random-access memory, and therefore performed their conversion from the page to be printed (e.g., Postscript™ into a bitmap on the associated personal computer that then shipped the entire bitmap to the printer. The benefit of this approach is that users designing models can already. A limitation of this approach is maintenance, as this requires the application subsystem to know about the laser cutter subsystem or even multiple or many laser cutter subsystems, so that changes or new features in the laser cutter subsystem may require the application subsystem to be updated as well.

An example session proceeds here as follows: the application extracts from the model the features the model contains. In the case of our example cajon, this might be “cutting 8 mm birch”, “1 mm-depth engraving into birch”, and “cutting 3 mm okume wood”. “box joints between 8 mm birch”, and “box joints between 8 mm birch and 3 mm okume”. The application now asks the laser cutter for the settings required to produce these features, which the laser cutter determines by running gauges and sends the information back to the application. The application now applies the settings and finally exports the model to the laser cutter-which at this point can be accomplished using a much wider range of file formats, such as SVG or even by lower-lever commends, such as move_head_top( ) or even geode. The main limitation of this approach is that it requires applications to know about all available laser cutters and their inner workings.

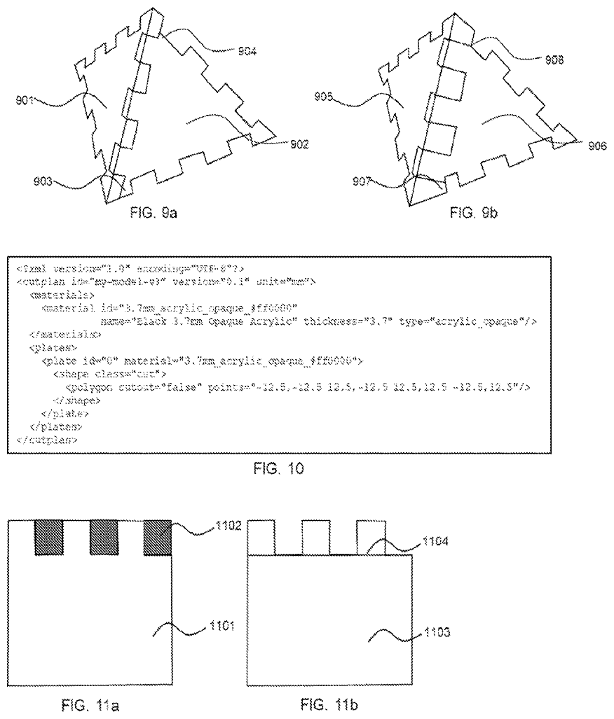

FIG. 8 shows an example implementation following the “dumb application subsystem model”. It also illustrates one specific set of components that can be used to implement this and other embodiments, such as the application system kyub and a Trotec Speedy 360 laser cutter running under Trotec Ruby and some custom hardware. Written in python, the system communicates with kyub by means of a TCP REST API. The system also uses a REST API to upload the cutting plans into the system. As camera it uses an ultra-wide-angle ELP 8MP IMX179 USB Camera mounted to the cutting head.

### 7 File Format Representing an Adjustable Model

Different embodiments may use different file formats. File formats include, but are not limited to the following options and combinations thereof:

1. Point-based format: A point-based format, such as the aforementioned LaserSVG, contains individual plates described by the control points that make their outlines. Point can then be complemented with an additional vector that offsets the point once the calibration information is known. The vectors may therefore contain parameters, in particular those making reference to calibration information, such as, for instance “(10, 20)+ (1, 0)*kerf)”, where “kerf” makes reference to the width of kerf as determined by a calibration process. This approach is limited in that does not allow encoding cases in which changes in material thickness lead to changes in geometry. FIG. 8 shows such a case, where increasing the thickness of the plate 801 causes its neighbor plate 802 to change its number of corners. Both triangular corners 803 and 804 get removed in that process. Such changes are difficult to express in point-based formats.

2. Plate-and-joint-based format: In a joint-based format, such as the aforementioned metaSVG, the file format describes the individual plates the model consists of. In the description, these plates are simplified in that the joints have been removed, so that the edges that would normally contain joints appear to be straight. Each of their edges is annotated with the type of joint (and parameters, such as widths, etc.) that the exporter should create for this edge, such as box joint, T joint, cross joint—and a much richer set for milling machines (dove tails etc.). This class of embodiments is viable, yet subject to certain limitations: (1) The exporter is limited to a finite set of joints. Therefore, introducing a new joint type requires an update of the laser cutter component. (2) The adjustment of the joints and coordination at corners requires full 3d information (e.g., which edges meet at what angle at a corner) to allow for the correct offsetting on corners where more than three plates meet. Limitation: this class of formats requires the decoder side to know all possible joint types in advance, which can lead to maintenance issues (i.e., updating the decoders in every machine using it), when a new joint type is introduced. Otherwise, they cannot reproduce the modeled joint geometry in detail as they resolve corner coordination on a 2D level

3. Shape-based formats. In this format, each of the plates the model is represented as more or more shapes, such as polygons, circles, ellipses, etc., as well as corresponding types of cut-outs. The key to this approach is that it allows all shapes belonging to one plate to be processed separately during calibration; they will then be merged back into a single plate (i.e., “positive” shapes united and cut-outs removed) before fabrication starts with the help of a polygon clipping function, such as [Francisco Martínez et. al. 2009. In Proc. Computers & Geosciences, 1177-1185]. Shape-based formats offer the most “expressive” results as it is not subject to the limitations of the two formats listed above.>

Thus, all three types of formats work to some extent. In the following we focus on shape-based format, as this allows us to explain the entire spectrum of features. Other embodiments may use point- or joint-based formats, albeit with a reduced feature set.

### 7.1 an Example (Shape-Based) File Format

FIG. 10 and subsequent figures show examples of one possible shape-based file format. It allows encoding the additional information necessary for adjusting various parameters, including and in particular parameters the value of which will not be determined until calibration time, such as kerf, actual material thickness, etc.—as well as user/editor-defined parameters.

We will refer to this particular file format as “cutplan”. Unlike a standard Scalable Vector Graphics (aka SVG) file format, in cutplans (1) the individual shapes contained in a file are tagged as either material or cutout. This clearly distinguishes parts from serap and also indicates the direction in which offsets need to be applied in order to compensate for kerf (i.e., edges will be offset away from material and towards scrap). (2) the control points of shapes are represented as arithmetic expressions. These are allowed to contain variables, making reference to, among others, the particular parameters the value of which will be determined at calibration time, such as the actual material thickness of the material and kerf.

FIG. 10 shows an example of a minimal cutplan that represents a 25 mm×25 mm square plate, fabricated from 3.7 mm opaque acrylic. This particular file format is based on the xml standard [W3C, 1998, Extensible Markup Language (XML)], but other embodiments may use other formats, such as json [Ed. DT. Bray, 2013, The JavaScript Object Notation (JSON) Data Interchange Format] or Protobuf [Google, 2008, Protocol Buffers]. As illustrated by the example, the file contains a header stating the version of the file format, the unit for all measurements in the file and optionally a model id. Furthermore, the file contains a set of materials, and a set of plate definitions, here consisting of the single square plate. In the material section, each material type is identified by its unique id (here id=“3.7 mm_acrylic_opaque_#ff0000”) that is used to both identify it in the context of a material management systems, as well as allowing the plates to reference the type of material expected for fabrication, the thickness the material was expected to have during modeling to be “3.7” (mm) and that it is of type=“acrylic_opaque”.

Here, “acrylic opaque” is an example of a “class of materials”. We discuss this concept and its distinction from actual sheets of material later in this disclosure, but, as a preview such a “class of materials” will be translated into an actual sheet before fabrication starts and there are a number of ways this “mapping” from “class of materials” to actual sheets can take place, such as (1) by the application subsystem asking users to map it to an actual sheet, (2) By the user having scanned one or more actual sheets and the system then mapping these to the materials in the model based on similarity, (3) by automatically detecting material(s) located in the cutter and mapping these to the material(s) in the file based on similarity, (4) by the laser cutter subsystem asking the user to place a matching sheet into the cutter, etc. Alternatively, the ID tag may also be used to pass the ID of an actual sheet of material, in which case no mapping to actual sheets is necessary anymore (even though embodiments might allow for remapping the different sheets in order to allow replacing sheets that turn out to be broken, lost, or just to give users the design choice).

Each plate in the plates section represents a 2D component in its own local coordinate system, which allows arranging parts on a sheet (aka nesting) without having to re-write all coordinates. (Alternative embodiments may still follow the traditional approach of using a single global coordinate system, as used, for example, by SVG). Each plate is described by a set of shapes, such as polygons. Each shape can be material (“cutout=false”) or a cutout (“cutout=true”). The sole polygon in this file forms a single 25 mm square centered around the origin. (This particular format uses commas to group numbers into coordinate pairs and spaces to separate points; different embodiments may choose different ways of encoding this).

This specific file does not contain any variables. In particular, it thus does not make reference to any of the parameters to be determined at calibration time. After adding vectors moving plates to their positions on the material sheet (aka “nesting”), the coordinates in this file are thus the final coordinates.

That said, some embodiments may choose to simplify the handling of kerf, i.e., instead of adding kerf to essentially everything, they may use a global rule saying that kerf be applied to all shapes by default. In the shown example, the square would thus be dilated by kerf, i.e., all point coordinates would be pushed outwards by kerf. Generally, the system dilates (shapes or) plates in the aforementioned direction from material to scrap.

### 7.2 Variables in the File Format

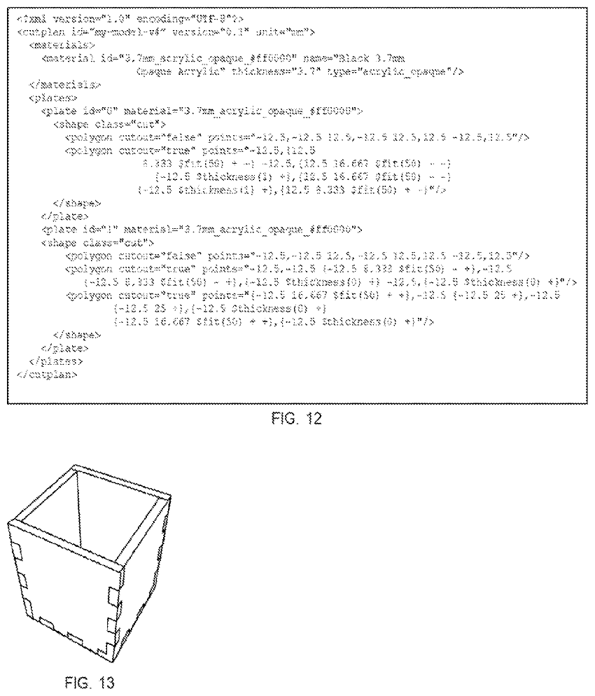

FIG. 11 and FIG. 12 illustrate a slightly more advanced example. They describe two plates 1101 and 1103 held together by a press-fit box joint. The cutouts 1102 assigned to the plate in FIG. 11a form the fingers of the box joint that will grow into the plate when the adjacent plate increases its thickness. The additions 1104 assigned to the plate in FIG. 11b will also grow in this case, but will in doing so increase the total size of the plate.

The file shown in FIG. 12 uses arithmetic expressions to describe parts of the geometry that refer to dimensions that might be adjusted during a calibration process. In the shown example, for example $thickness(0) evaluates to the thickness of the material from which the plate with id 0 will be cut. The variable $fit(50), as another example, asks the system to determine how much the plate is expected to compress under the specified load passed as parameter, here 50N. Alternative embodiments may express loads differently, e.g., in different units, or in terms of pressure, or some otherwise related physical property.

### 7.3 Representing how Changes in Material Thickness are to Take Effect

There are multiple reasons why the material thickness in a model may have to be adjusted. It is not uncommon that the thickness of actual material sheets is not the one specified by the manufacturer; a 4 mm sheet of plywood, for example, may by only 3.8 mm thick. Furthermore, users may instantiate a “class of materials” late or replace the “actual material sheet” assigned to a model after the model was encoded in a cutplan. Some embodiments may therefore offer ways to adjust material thickness after the fact.

Adjusting material thickness is a non-trivial endeavor, because the correct action to take, in particular in which “direction” to adjust the thickness of a plate depends on the application scenario at hand. The cup depicted in FIG. 13, for example, may be intended to contain objects of a certain size or a certain amount of liquid. In this case the inside dimension of the model should be preserved, i.e., any changes in material thickness should grow or shrink the cup “outwards”. In contrast, if the cup is intended to be contained in another container of a certain size (such as, when the box is intended to form an inset inside a larger box), then the outside dimension should be preserved and any change in material thickness should grow or shrink the cup “inwards”. Other models might require distributing the change in material thickness to affect both the inside and the outside dimension in a defined proportion (e.g., to preserve the position of the center of a plate). Cutplan thus allows mixing additions and cutouts to encode this in analogy to the approach already illustrated FIG. 11.

The plate shown in FIG. 11a is represented of its square base shape and 3 cutouts. The height of these cutouts is dependent on the thickness of the mating plate, while the width is dependent on kerf (larger kerf leads to thinner cutouts). In the cutplan format, such a hole could be described by putting <polygon cutout=“true” points=“−12.5. {12.5 8.333 $fit(50)+−}−12.5, {12.5 16.667 $fit(50)−−} {−12.5 $thickness(1)+}, {12.5 16.667 $fit(50)−−} {−12.5 $thickness(1)+}, {12.5 8.333 $fit(50)+−}”/> into the plate polygon section. This allows the plate to keep a consistent outer dimension, irrespective of the material thickness.

FIG. 11b shows the plate represented as a rectangular base shape and 3 additions. The height of each of these additions is, again, dependent on the thickness of the mating plate. While the width is dependent on fit adjustment (larger fit leads to wider additions). In the cutplan format, such an addition could be described by putting <polygon cutout=“false” points=“−12.5, {12.5 8.333 $fit(50)−−}−12.5, {12.5 16.667 $fit(50)+−} {−12.5 $thickness(1)+}, {12.5 16.667 $fit(50)+−} {−12.5 $thickness(1)+}, {12.5 8.333 $fit(50)−−}”/> into the plate polygon section. This allows the plate—when assembled—to keep a consistent inner dimension (i.e., a consistent distance to the start of the joint), irrespective of the material thickness.

For some types of joints, the required joint length requires scaling the thickness or incorporate additional information such as the joint angle for non-90-degree box joints. In similar fashion, we can encode variations in fit so as to allow for an easier fit for longer joints, for non-90-degree joints, for joints that do not allow the use of tools, such as a hammer, and so on. In the cutplan format such more complex variations can be encoded as expressions in the polygon sections: <polygon cutout=“true” points=“−12.5. {12.5 8.333 $fit(50)+−}−12.5, {12.5 16.667 $fit(50)−−} {−12.5 sin(60) $thickness(1)*+}, {12.5 16.667 $fit(50)−−} {−12.5 sin(60) $thickness(1)*+}, {12.5 8.333 $fit(50)+−}”/>.

The cutplan format allows encoding a wide range of additional geometric manipulations. In order to distinguish “presentation models”, which users might want to polish so as to eliminate the burnt edges from working models, which users might leave as is, the file may leverage an additional variable called, for example, “polish”. By encoding the lengths of the “fingers” in FIG. 11b as {$thickness(1) $polish 2*+} and interpreting the Boolean variable “polish” as 0 or 1, the finger gets extended by 2 mm if the Boolean value polish is true. Changing this value can be done using any type of button or switch (such as hardware switch labeled “polish” located at the laser cutter or a software button “polish” labeled located anywhere, etc.) flipping the value of the polish variable now produces the correct model—for models already encoded as a cutplan.

Different embodiments may support different sets of variables. The list of useful variables includes kerf (measured using e.g., Kerfmeter, used e.g., for press-fits), thickness (measured using e.g., level sensor, depth camera, used for accurate model dimensions), sanding (user entered, elongates edges of the model), or the scaling of cutouts for external parts (either user entered, by automatically identifying them or by automatically measuring them) (we refer to these as assets). In addition, cutplan file formats may contain any number of other variables deemed useful. Different embodiments may choose different names for these variables and they may be written in different formats. The shown embodiment expresses these in the form resembling a function call; other embodiments may use any other type of arithmetic notation, such as postfix, prefix, infix, object-oriented method calls, or any other such format.

### 7.4 Decoding and Adjusting

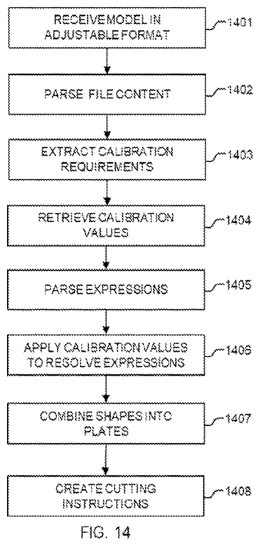

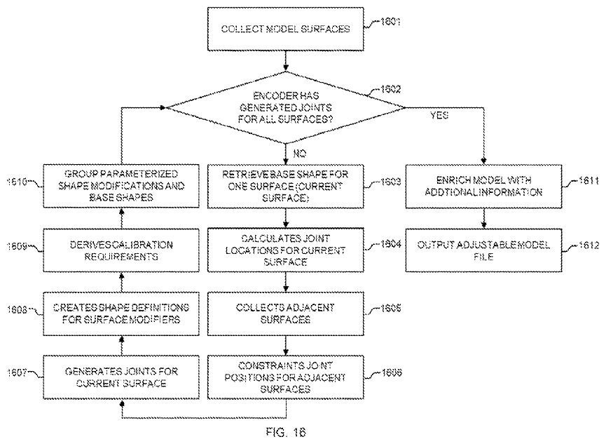

FIG. 14 shows a flowchart of a cutplan decoder. 1401 The decoder receives a model file in an adjustable file format such as cutplan. In an embodiment where cutplan is used, the decoder 1402 parses the file using an XML parser, such as txml (https://lxml.de) or similar. 1403 The decoder then identifies which calibration steps should be performed. In one embodiment, calibration steps for each plate can be derived by identifying all variables that are part of any expressions in the file. 1404 It then retrieves the values for all these variables. It might, for example, (a) look up variables in the variables section of the cutplan, (b) look up previous values, (c) ask the user to run a calibration process, or (d) run an automated calibration process, as discussed in more detail below. It may, for example, ask for the thickness of the current material, e.g., by measuring it using a gauge, recall the last calibrated setting, etc. Similarly, for $fit( ) the system may recall values from earlier measurements or request a user to determine this value, e.g., using an appropriate kerf strip [https://elplatt.com/lasercutter-kerf-gauge], or may trigger an automatic measurement, e.g., using Kerfmeter, see below. Once a value has been assigned to all variables, the decoder 1405 parses the expressions, 1406 replaces occurring variables with appropriate calibration values, calculates the arithmetic expression and in so doing retrieves the actual polygon outlines. 1407 For each shape all polygons are then merged by using a suitable algorithm (e.g., the Martinez-Rueda-Feito Polygon Clipping algorithm, the Sutherland-Hogman Polygon Clipping algorithm, or others). The resulting combined polygon describes one of the shapes of the plate. A plate might consist of multiple shapes that each describe different kinds of cut paths such as cut lines, line or raster engravings or crease lines. 1408 Some embodiments may use SVG as a format for describing the resulting plate shapes, along with calibrated cut settings while other embodiments may use a format for machine instructions such as GCODE.

In order to avoid values being measured multiple times, embodiments may first collect a list of all of these variables, optimize the list, e.g., by removing redundancies, group similar measurements, optimize the order in which to evaluate the variables, pass them on to the respective subsystem in order to invoking the necessary calibration steps. Other embodiments may decide for each value whether they should measure it or rely on the already measured values. Alternative embodiments of the file format contain the list of necessary calibration steps, potentially with fallback values.

The workflow described above decodes the cutplan and applies the calibration information in a single integrated process. Different embodiments may separate the two steps into a decoder followed by a separate adjuster, which then produces a model description containing the actual dimensions. The process described above achieves this adjustment by evaluating the expressions contained in a cutplan in the context of the values determined by calibration.

Other embodiments based on different file formats, perform the adjustment step differently. When using a point-based format, the adjuster works quite similar to the algorithms described above, i.e., it moves points by evaluating variable determined during calibration; unlike the process for shape-based formats described above, there is no merging of shapes into plates. When using a plate-and-joint-based format, in contrast, the adjuster now generates joints based on the variable determined during calibration and merges them into the model.

While the file formats shown above essentially encode data, other embodiments encode models as files containing program code. Historical examples for doing so include Postscript™. Someone skilled in the art would know how to apply the same approach to the encoding and decoding of files for subtractive fabrication.

Many embodiments of laser cutter subsystems will feature decoders for multiple file formats, allowing application to choose. The choice of file format has a range of implications, including digital rights management. (1) The most comprehensive way of sharing a model is in its 3D format, such as kyub or flatFab, allows making all types of changes to the model and at least conceptually allows fabricating on any laser cutter. These formats are enabled by simple adding the decoder for the respective format also to the laser cutter subsystem. (2) Sharing in an adjustable file format, such as cutplans, still allows fabricating on any laser cutter. (3) Sharing in a reduced adjustable file format, such as cutplans with some variables instantiated, allows fabricating on many laser cutters. (4) Sharing a model in SVG format is most specific and thus further reduces the opportunity of further sharing, as the model would produce less well on other machines. A way of producing such an SVG format worth mentioning is users uploading the parameters of a specific (e.g., their) laser cutter calibration information and material to a platform (e.g., the application program) running a cutplan decoder. The platform then runs the decoder in the context of the uploaded calibration and material information and responds by sending the resulting SVG etc. back. This model is now calibrated for the particular machine and material, making it useful for the user, but less useful for others. A sharing site may offer multiple options and charge more for the more comprehensive file formats, e.g., pricing (1)>(2)>(3)>(4) (e.g., combined with a more comprehensive license).

7.5 Determining the Features that Require Calibration

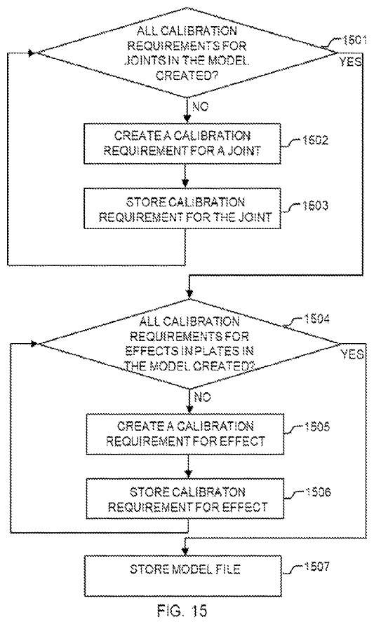

FIG. 15 shows one embodiment of a workflow to determine the features that require calibration. In one embodiment this feature extraction takes place within the encoder of the model. For this process, the system 1501 iterates over all joints contained in the model, 1502 creates a calibration requirement for this joint (e.g., needs to cut through the material it's fabricating from and in the case of box joints needs to calibrate for a press fit as well as the thickness of the joined plate) and stores the calibration requirement for the joint.

The encoder then 1504 iterates over all effects on plates in the model. These are, including but not limited to, markings, engravings, cutouts, and/or living hinges. For each of these effects the system 1505 creates a calibration requirement and 1506 stores it. Afterwards, 1507 the system stores the model file with the calibration requirements.

In other embodiments, the system uses a different order in which to collect these features, extracts the features while it collects the geometry information, and/or stores the result of the feature extraction in a separate section of the model file or in a separate file. In other embodiments the feature extraction step includes deduplication of the found features or orders them. In different embodiments, the feature extraction happens in the decoder, using the information from the file format. In a different embodiment the feature extraction takes place in a standalone component.

### 7.6 Encoder

In order to send a model to be fabricated to a laser cutter subsystem, applications encode their models in a file format. Different applications may support one or more such formats. For models the quality of which does not rely on much calibration (such as a simple 2D piece key chain), applications may continue to use traditional formats, such as SVG or similar. However, especially for models the quality of which does depend on calibration of kerf and fit (such as a 3D model of a chair, where plates are connected by various types of press-fit joints), information about the 3D arrangement of plates might be necessary in order to determine how calibrated values affect plate outlines. Therefore, applications might export a 3D model format that preserves those information or a 2D format that encodes how calibrated values affect cut paths, such as cutplan.

FIG. 16 shows how an encoder produces a cutplan file from a 3D model. 1601 The encoder collects all model surfaces and, 1602 for each of them, 1603 it retrieves the base shape (meaning the shape outline without joint elements) and 1604 calculates joint positions for the current surface, respecting constraints that may exist as described below. The encoder 1605 collects all surfaces that are connected to the current surface and 1606 constrains joint positions for them to match the joints generated for the current surface. This can mean generating corresponding joint elements on adjacent plates directly, or alternatively storing constraints for later evaluation. The encoder 1607 generates parameterized polygon outlines for every joint element. In some embodiments, this means directly changing the base shape outline, while in other embodiments, the joint elements are stored as separate shape modifications that may include a clipping hint (such as “subtract from base shape”). Depending on the joint type, creating the joint element outlines may incorporate 3D information such as joint angle, especially for points where more than two plates meet.

The “base shape” of a plate is a representation of that plate before the joints have been added, so that all edges to bear joints later are still straight. In the case of a plate featuring box joints, for example, the “fingers” along each edge are not there yet, making the plate at that edge shorter, or the cutouts are not cut yet, making the plate at that edge longer.

For 1508 Surface modifiers such as raster or line engravings, markings or cutouts for assets (including but not limited to motors, bolts, switch mounts, speakers, etc.) that may require mounting holes on one or multiple surfaces, the encoder may create additional shape definitions or may modify existing shape definitions of the affected surfaces.

As described above, in some embodiments the encoder May 1509 derive information about calibration values that the whole model or parts of it depend on from the generated shapes, including but not limited to thicknesses of specific plates, fit of a specific material or marking darkness calibration. Such calibration requirements may be saved in the output file by including relevant spatial model data such as plate arrangement or asset information from which a decoder would later derive the resulting shape modifications or as variables in parameterized expressions, that describe how a specific calibration value alters the shape.

The encoder 1510 groups all shape definitions from a surface and creates a plate definition that may include additional information such as the material on which the plate should be cut. The encoder 1511 might include additional model information such as a model identifier for fetching additional information about the model at a later time, a material list that may include material information such as material class or expected material thickness or nesting information. Finally, the encoder 1512 stores the model along with the aforementioned additional information in an adjustable file format for subtractive fabrication such cutplan.

Some embodiments may use adjustable files, such as cutplans solely for the purpose of transferring a model to a laser cutter. Other embodiments may store or share adjustable files, such as cutplans, for later use, such as to store them or share them in a repository.

### 8 Gauges

As mentioned above, the system of the present invention contains one or more components we call gauges. The purpose of each gauge is to obtain information about the current calibration state of the laser cutter. The purpose of most gauges is to examine the effect that applying some cutting action does to a material sample located inside the cutter.

While we will present gauges primarily in the context of the overall system of the present invention, all gauges can generally also be made and used in stand-alone usage.

The core functions of a laser cutter tend to be to cut, to engrave, and to mark and, less common so, to bend (e.g., [Stefanie Mueller et. al. LaserOrigami: Laser-Cutting 3D Objects. In Proc. CHI'13, pp. 2585-2592]), to weld (e.g., [Udayan Umapathi et. al. LaserStacker: Fabricating 3D Objects by Laser Cutting and Welding. In Proc. UIST '15. 575-582]).

However, the different settings tend to produce different results. For example, even when two sets of setting both succeed at cutting the material, the outcome may vary in terms of (1) the amount of time required for cutting, (2) the risk/amount of burn marks on the material (e.g., as the result of fumes igniting), (3) the quality of the resulting edge, (and to a lesser extent (4) the resulting kerf, (5) the slant of the kerf). Many gauges therefore sample a number of different settings (we will refer to a fabricated sample representing one sample of settings as a “swatch”), observe the outcome, and report back the settings that produced the best results.

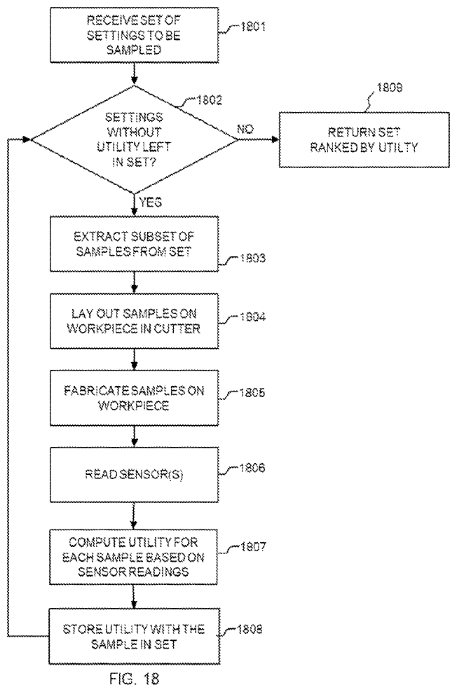

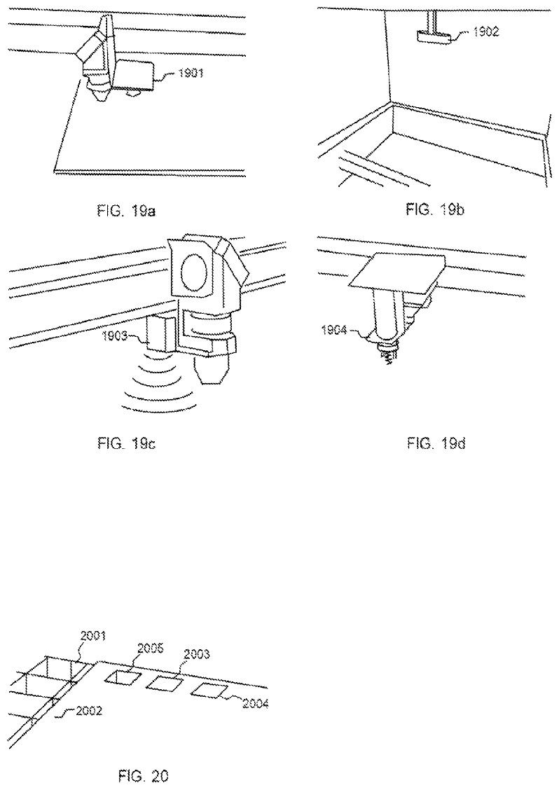

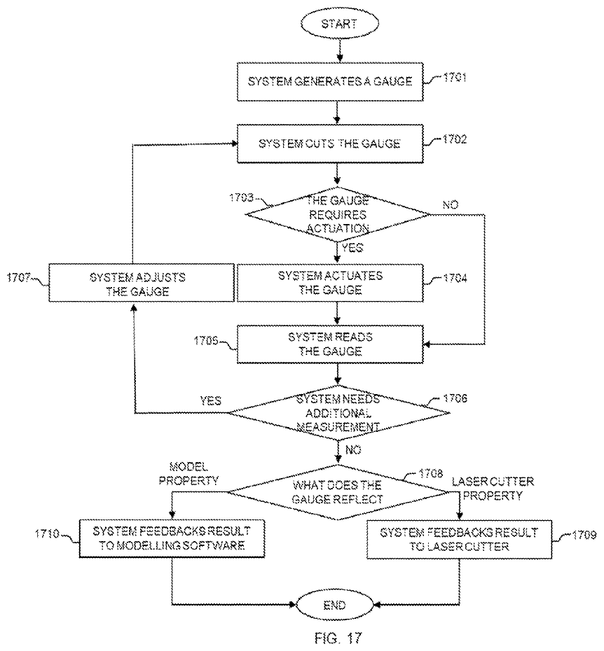

FIG. 17 shows one possible process for implementing a gauge based on cutting material. For each parameter to be calibrated the system proceeds as follows: (1) The system generates a specific laser cuttable model, the purpose of which is to make one or more (otherwise invisible) parameters of the laser cutter visible to a camera or readable with some other type so sensor. We will refer to these models as “swatches”. If they consist of a series of elements to be cut or engraved, we will refer to these individual elements as “swatches”. (2) For gauges that require actuation (such as the kerf gauge, see below), the system actuates the gauge. (3) The system reads the gauge, extracts the contained information and assesses it. (4) If the system determines that additional measurements are needed, it adjusts the gauge accordingly and repeats the cut-(actuate)-read-assess process. (5) feeds this information back either to the cutter (such as how much “power” (energy per millimeter) required to cut this material) and/or (6) to the modelling software or similar conversion software, so as to allow it to generate a new version of the model that reflects the parameters determined with the help of the gauge (e.g., kerf, causing that software so dilate or erode the parts of the model).

As illustrated by FIG. 18, gauges generally identify “best results” with the help of a so-called utility function 1807, i.e., a function that maps observed outcomes to a scalar utility value, so that the settings producing the highest utility value is the desired best result 1809. Gauges may compute utility values using a function that computes utility as a function of the one or more observed dimensions. Some embodiment may, for example, compute the utility of a cut operation as—w1*(percentage of samples that did not cut through)−w2*(percentage of samples that resulted in burn marks)−w3*(time required for a cutting a sample in seconds). This will favor settings that (1) produce parts (2) without burn marks (3) quickly. Adjusting the weights w1, w2 . . . allows expressing the tradeoff between cutting success, burn marks, and cutting time. In contrast, gauges observing only a single sensor value per setting often allow for much simpler utility functions, such as the value or negative value delivered by the sensor. Other embodiments may implement different utility functions, as described in [Keeney & Raiffa. Decisions with Multiple Objectives: Preferences and Value Trade-Offs. Cambridge University Press. 1993].

Gauges may sample the space of settings using various algorithms, ranging from exhaustive search (i.e., the gauge fabricates all requested samples) to search algorithms that try to find the global optimum with fewer samples and thus faster and with less material consumption. Such algorithms include the entire gamut of sampling algorithms, including binary search (in order to optimize a single factor), gradient descent (the gauge fabricates a pair of samples, evaluates them, determines the difference between the two, and extrapolates this “gradient” towards a point where the function is expected to become optimal), Newton iteration, beam search (the gauge fabricates a smaller subset of samples, assesses them, identifies a subset of samples that did well, and varies these to determine the set of samples for the next round), and so on.

If gauges are invoked as part of the fabrication process for a specific model, many embodiments will speed up the calibration process by identifying only those settings that produce outcomes actually required by the model at hand. If a model only contains marking with 30% and 100% darkness, then only these would commonly be calibrated for, rather than the entire grayscale range.

Algorithms may also deploy various strategies designed to further reduce the search space, e.g., by first identifying one setting that barely cuts through (e.g., using binary search between full power and zero power) and then exploring settings of similar energy/cut length, e.g., by decreasing power and speed simultaneously and to a comparable extent or by switching from a single pass to k passes, while simultaneously reducing the cutting power by a factor close to k.

For laser cutters enforcing a minimum round-trip time (e.g., those made by Trotec) it may be more efficient to cut multiple swatches each time, than a strict “binary” search.

Other gauges do not require sampling a space of settings, but are given a single setting for which they determine the consequences. For example, a gauge may, given a specific cutting setting, test cut using these settings and observe and report back the resulting kerf.

As mentioned, most gauges sample the material in the laser cutter by cutting one or more swatches. This means that these swatches consume some of the material in the cutter-material that could otherwise be used to cut models. Gauges may minimize material consumption, by using any subset of the following strategies: (1) use very small swatches (even though some gauges may make them large enough to make them visible to the cameras or large enough to give them sufficient mass to drop reliably, etc.) (2) Pack swatches closely (even though some gauges may imply additional layout constraints, such as positioning over an opening), (3) minimize the number of swatches cut by using an optimizes search strategy, (4) using part of the material sheet that is located along the edge or even better in an area considered scrap.

Since gauges compete and model access the same resource, i.e., the material sheet(s), many embodiments coordinate the layout of the swatches and of the layout of the model (aka nesting), e.g., by the nester reserving (an estimate of the) space for the swatches or by running calibration first and then nesting on the remaining material.

### 8.1 Avoiding Burn Marks

As mentioned above, one of the aspects of utility functions is burn marks, which are often considered undesirable. Burn marks can be caused by a range of situations, such as fumes igniting, local overheating, and so on. Some gauges will sense burn marks after the fact, e.g., by observing the result of a cutting/engraving/marking process with a camera, and using camera vision technique to identify burn marks, e.g., by taking an image before cutting/marking/engraving, an image after cutting, subtract the latter from the former, mask out areas where cutting/marking/engraving took place—and sum up the darkness of the remainder). Other gauges will instead or in addition sense burning during cutting/marking/engraving, e.g., using a camera, a heat camera, a heat sensor etc.

If burn marks are assigned a negative utility in a gauges' utility function, gauges will identify settings that avoid burning, such as using multiple passes of lower “power” (i.e., energy per length) or adjusting the cutting order of individual features so as to prevent heat from building up locally, e.g., by alternating between locations, e.g., when cutting pattern, such as living hinges.

In addition, some gauges may deploy additional processes, such as dispensing moisture during cutting, increasing ventilation, activating (additional) ventilation at the laser head, the release of non-burning gas, or trigger fire extinguishing mechanism [https://www.ulsinc.com/discover-uls-innovations/fire-suppression] and so on.

Finally, gauges may escalate the presence of burning to the user, requesting the user cover the material foil, paper, masking tape, moisture, etc.

### 8.2 Sensors and Actuators

Gauges obtain their raw information from at least one sensor. The individual gauges that are part of the present invention may make use of one or more of the following hardware elements, shown in FIG. 19 mounted to the (inside or) the laser cutter: (1) One (or more) detail cameras 1901 that can be pointed at individual spots of the workpieces, e.g., by being attaching to the laser head. Some embodiments of our system may use it to sense burning, evaluate burn marks, check whether cutting, assess the darkness of engraved areas, assess the depth of engraved areas, etc. (2) One or more wide-angle cameras 1902 that observe the space containing the material. Our system uses it to recognize position and shape of the material/workpiece/plank to be cut from. If this camera(s) is of sufficient resolution, it may also be used to assess the parameters that would otherwise be senses by a detail camera. (3) Optionally a distance measuring tool 1903, e.g., a range finder, to depth of engraved areas and/or calibrate depth (4) Additional custom tools 1904, such as the “kerf” measurement tool shown below. It contains additional components, such as a motor, a driver board, power supply etc. Some embodiments also contain a microcontroller (e.g., Arduino, Raspberry Pi, . . . , etc. Different embodiments feature different subsets of these hardware components.

In addition, the present invention may also feature a moveable camera that traverses the laser cutter recording multiple images or footage, and stitching these into one or more images that covers a larger field of view, such as the entire cutting volume. One way of eliminating motion blur is to add substantial lighting to the cutting volume. Another is to pause the actuation while taking the relevant images. One way of implementing this is by sending a “model” to the laser cutter that places cuts with 0% power at the intended the positions where photos need to be taken. These images can later be identified in footage by identifying the frames where optical flow is close to zero, or where acceleration is between a deceleration and an acceleration (measured using an accelerometer attached to the moving head), or my synchronizing with the actuation system.

Many additional sensors may be used, such as (4) Speckle sensors. (5) Depth cameras, such as structured light, time-of-flight depth camera or similar, Lidar, etc. (6) 3D scanner, e.g., by processing any of the above of similar using a 3D reconstruction software. Additional sensors may include, but are not limited to encoders, laser barriers, switches, sensors that sense the speed and or direction of air movement, smoke detectors, etc.

### 8.3 Cutting Gauges

As mentioned above, laser cutters offer multiple options for cutting material, such as cutting power (e.g., specified as a percentage of the maximum power the built-in laser source is capable of producing or in Watts, etc.), speed (e.g., specified as a percentage of the maximum speed the built-in gantry is capable of moving or in m/s, etc.), and number of passes (i.e., how many times the cutting laser will move along the same path; optionally, passes could differ). Additional factors include the laser's pulse frequency and/or focus length (e.g., relative to the top of the material sheet), and ventilation intensity etc.

By sampling different (cutting power, speed, number of passes, pulse frequency, focal length, ventilation) vectors, a power gauge may identify settings that perform better than others, such as: they still cut through the material, while avoiding burn marks and minimizing cutting time.

One approach to sampling a setting is to cut a shape and the to test whether it has cut all the way through. We will refer to this shape as a swatch. If the swatch is to be evaluated using an optical method (see below) the swatch may have any shape, such as short line. If the swatch is to be evaluated by moving the inset (see below) any closed shape will do, such as a square or a circle.

Different embodiments may use different approaches to verifying successful cutting. Some may observe the swatch's outline using one or more cameras observing the material (e.g., illuminated from the backside in order to highlight the cut), and run computer vision algorithms to extract the cut from the image. e.g., such as a connected components algorithm. If the algorithm identifies more than one component in the area of the swatch (i.e., the perimeter and a separate inset=the swatch), then the swatch has been separated successfully. Other embodiments may observe the cut using a depth sensor from above looking at the cut perpendicular to the workpiece. Yet other embodiment may observe the backside of the material and look for a closed curve there. Yet other embodiments may observe (a small segment of) a cut from the side to see whether the cut extends all the way through).

Another line of embodiments may apply a force to the swatch and observe whether it can be moved separately or removed from the surrounding material. There are multiple ways to apply a force, e.g., by blowing an air jet (or water jet) at it, by pushing or gripping it with a prong, or using gravity, etc.

The setup shown in FIG. 20 fabricates swatches over an opening, here an inset with openings, as commonly used in laser cutters for ventilation purposes, e.g., in the here shown form of a grating. The workpiece 2002 has been placed over a grating 2001 and three swatches located over openings in the grating have been cut, with 2005 having dropped, while swatches 2003 and 2004 have not dropped. (Alternative embodiments may produce an overhang, e.g., by propping up the workpiece in the laser cutter).

Here a dropped swatch 2005 suggests a successful cut, and thus settings of sufficient “power” (as in energy/length). In order to locate swatches over openings, a gauge initially may identify openings in the first place. Some embodiments may do so using manual help from the user (e.g., by users entered coordinates) or in an automated fashion, e.g., by taking a photo of the cutting space while no material is present, optionally correcting for illumination differences, e.g., by subtracting a blurred version of the image, and using a segmentation algorithm (e.g., correct components algorithm) to identify openings, which tend to appear dark in the image.

Gauges may then verify that a swatch has dropped, e.g., by observing the swatch using one or more cameras (e.g., optionally illuminated from the backside in order to highlight the opening or from the front, in order to highlight the material), and run computer vision algorithms to extract the cut from the image, such as a connected components algorithm. If the algorithm identifies a (swatch-size) component in the area of the swatch, then the swatch has dropped. Other embodiments may use different sensors, such as microphones, range finders, etc.

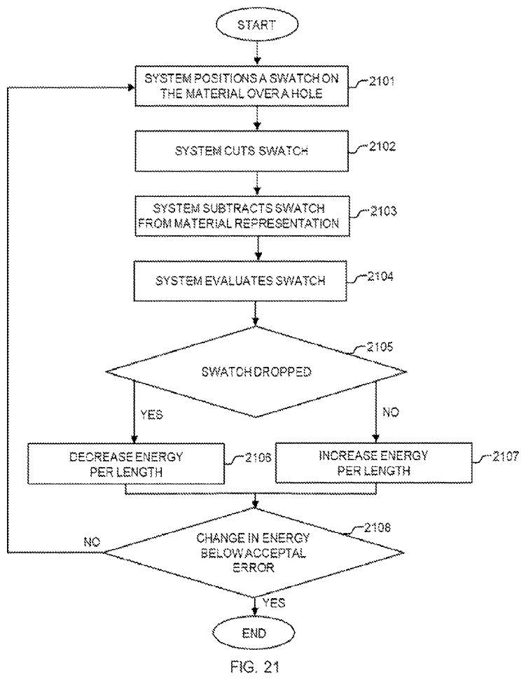

FIG. 21 shows another embodiment based on a simple utility function, namely only whether the material has been cut-within a specific margin of error (optionally passed as an input parameter). Before the process can start, the system must have already determined the position and period of the grid, as discussed earlier.

The algorithm starts by positioning (1) When material is present in the cutter, the system locates a piece of material. (2) The system 2101 positions a closed shape, such as a rectangle or circle (aka “swatch”), etc. onto the material over one of the holes in the grid. The shape must be smaller than a hole in the grid, yet ideally large enough to have enough mass to fall in step 4, below. (3) The system 2102 runs the cutter, so as to cut the swatch, and 2103 subtracts the swatch from its model of the material piece. (4) If the laser power is sufficient, the swatch is now separate from the rest of the material and can fall into the hole in the grid. Some embodiments design the swatch to be large and thus heavy enough to drop based on gravity; other embodiments may apply an additional force to make the swatch drop, such as depress the swatch using suction from below, air pressure from above, a prong mounted to the gantry, etc.

2104: The system reads the swatch using one of the sensors listed above (one of the cameras, a range finger, some mechanical prong, etc.) and, as discussed above, 2105 now determines based on the sensor reading whether there still is a surface (suggesting the laser was too weak) or an opening now (suggesting the laser was powerful enough).

Based on this reading the system now adjusts laser power: If the swatch did not drop, the system 2107 increases laser power by step rate (or decreases speed, if already at maximum power), reduces the power step rate (e.g., by a constant factor) and restarts the process by jumping to 2101.

If the swatch did drop, 2108 the system checks whether power step rate is already below margin of power error. If so, the process terminates. Otherwise, it 2107 decreases laser power by the power step rate (or alternatively increases cutting speed by the corresponding amount, unless already at maximum speed) and restarts the process by jumping to 2101.

### 8.4 Cutting Gauges for Milling Machines Etc.

If the fabrication device is not a laser cutter, the settings to be calibrated tend to be different. For a milling machine, for example, a gauge may need to calibrate (1) the speed at which the milling head is moving through the workpiece (“cutter head speed”) and (2) the rate at which the milling head spins, and (3) the depth. The gauge may thus observe whether a swatch is fully separated from the material surrounding it/whether it drops, judge the quality of the resulting cut (e.g., by observing it using cameras and processing the camera images with a high-pass filter to classify shredded edges), and, in extreme cases, whether the tool head breaks.

### 8.5 Partial Cutting Gauges

Some laser cut models and/or materials require the material to be cut partially, i.e., only to a certain depth. For example, some models fabricated from a sandwich material, such as foamcore, may require cuts where only the top layer, the top two layers, etc. be cut.

The process for calibrating such partial cuts is largely the same as for regular (all-the-way-through) cutting, except the methods for evaluating the outcome of each swatch have to be adapted. In particular, the approach of letting a swatch drop under gravity does not apply here. Instead, the success of partial cutting may be verified by a number of alternative methods including, but not limited to: (1) observing the incision, e.g., using a depth camera or 3D camera or similar type of device largely perpendicular to the incision. (2) Observing an incision placed so as to reach or cross the edge of a part, e.g., using a camera or similar pointed at the edge of the material from the side. Then extract the depth of the cut, which here appears as a length, using computer vision techniques (such as segmentation, e.g., based on corrected components, then obtain length). (3) Observing the incision, e.g., using a camera or similar device largely perpendicular to the incision, while illuminating the material from the backside and measuring the brightness at the incision. This set-up would typically be calibrated by measuring samples with a known incision depth first. (4) Mechanically, by applying a force (as discussed above) or torque or sweep of force or torque. One possible setup features a “tab” (e.g., one partial incision completed into a shape, such as a square by all-the-way-cuts) with an actuated lever trying to break it. The amount of force/torque applied indicates the thickness of the material left. This set-up would typically be calibrated by measuring samples with a known incision depth first.

### 8.6 Marking Gauges

Laser marking refers to placing visual elements onto the surface of a part with little or no penetration (making it different from laser engraving, which refers to affecting the surface of a part with evident penetration below the surface of the material). Depending on the material, marking may make a surface lighter or darker. (Raster) markings can be produced by traversing a surface (e.g., line by line) with the laser.

Marking gauges sample a subset of the space of {power, speed, number-of-passes, pulse frequency, focus length, etc.} settings in order to identify settings that produce visually distinct results on the material at hand. As discussed earlier, utility functions will typically be a subset or combination to (1) the visual quality of the result, (2) risk of (unintentional) burn marks, (3) completion time, etc.

Accordingly, the swatches of marking gauges tend to be patches that are marked by the laser. These can have any shape. In order to optimize completion time, they may, for example be rectangular. Marking gauges then typically deploy a camera or similar optical sensor as sensor to assess the visual quality of the result, e.g., by taking an image of one (or more) swatches, (optionally, segmenting the swatch from the unprocessed material), and computing the brightness/darkness of the swatches surface in the image or the contrast compared to unprocessed material (captured in an earlier shot or in the same shot in an adjacent area, etc.).

Depending on the markings contained in a model at hand, the gauge manager may deploy different types of marking gauges. Black-and-white marking gauges determine how to obtain a single “color” (i.e., brightness or darkness) distinct from the regular material color, such as the most distinct color. These can be used for models containing black-and-white marking or to render gray-scale by first passing the images through a process that turns it into a black-and-white image, such as dithering or half-toning. Color images will typically first be desaturated and then treated like gray-scale images. Black-and-white marking gages sample a space of settings with a utility function that assigns high utility to visually distinct outcomes.

Grayscale marking gages, in contrast, determine how to obtain a range of “color” (i.e., brightness or darkness) distinct from the regular material color that form a linear brightness gradient. These can be used for models containing gray-scale images (without first passing the images through a process that turns it into a black-and-white image).

One way of implementing grayscale marking gages is to sample a space of settings once for every desired brightness value, with a utility function that assigns high utility to representing that specific brightness value. For performance reasons, however, embodiments more commonly perform the process only once and record the settings producing brightness values along the way until an array of all brightness values required by the model has been filled. To improve performance further, one would typically sample only a few key outcomes, such as settings that produces the most distinct color, settings that produces the lightest color different from regular material (and settings resulting in a few brightness values in between), and fill the rest of the mapping resulting function by means of interpolation. To improve performance further, some embodiments may choose to create multiple swatches or even a gradient at a time.

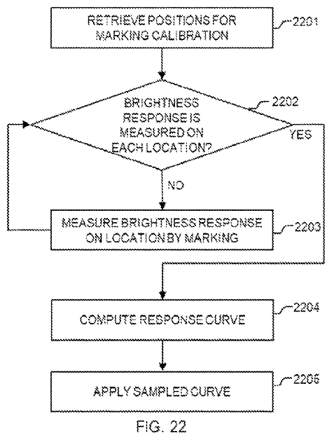

FIG. 22 shows the underlying process: A set of rectangular shapes is engraved and the brightness is read from the samples. Then the response curve between the provided grayscale value and the resulting brightness is read and a transfer function is passed back to the cutplan parser, which applies it to the engraving at hand.

### 8.7 Engraving Gauges

As mentioned above, laser engraving refers to affecting the surface of a part with evident penetration below the surface of the material.

Engravings gauges are largely identical to marking gauges except for the following differences: (1) Unlike marking, where the outcome was the visual appearance, the outcome of an engraving is the depth of the engraving. (2) Consequently, gauges will deploy sensors capable to sensing depth. A wide range of sensors are capable of doing so, including depth cameras, range finders, physical probes (such as touchprobe [ Antclabs]; to measure. e.g., raise the table holding the workpiece in small intervals until the touch probe makes contact which triggers an interrupt and retracts the probing), and so on. Different embodiments sense depth by placing a swatch at the very edge of a piece of material (e.g., by first engraving and then cutting a cutout across) and then observing the cut using a camera or similar from the side and running the aforementioned segmentation and measuring of the engraving. (3) For models that use engraving for decorative purposes, such as to create a relief, a utility function may satisfy with calibrating relative depth. For models that require a specific depth (such as 2.3 mm), e.g., to mount a technical component into the resulting opening or to remove layers from a piece of sandwich material, such as foamcore, the utility function for these gauges will refer to a specific depth, e.g., expressed in physical units, such as millimeters.

Apart from that, the processes for engravings gauges are largely identical to marking gauges.

### 8.8 Line Engraving & Marking Gauges

In analogy to (raster) markings and engravings that are produced by traversing a surface (e.g., by “scanning” it line-by-line) with the laser, line engravings and line markings are produced by traversing a line with the laser, thus forming vector “graphics”. Line markings and engravings have a range of applications, including, but not limited to (1) fast rendering of information, (2) giving additional contrast to raster markings or engravings by tracing the outlines of key elements.

Line markings and engravings gauges proceed in direct analogy to their raster counterparts, except that the focus length of the laser plays a particular role here. In particular, the line engravings and markings contained in a model may have a particular width associated with them and one way of producing wider lines is by defocusing the laser (e.g., by moving the cutting volume or the laser head up/down). Accordingly, line markings and engravings will commonly also consider line width as an additional part of their utility function. A line markings gauge may evaluate the width of a line in various ways, such as by sensing it using a camera, segmenting (e.g., thresholding and connected components algorithm), and then compute width either by divide surface by length of the line and by determining by how much a line can be erode until the surface turns below some epsilon, etc.

### 8.9 Material Thickness Gauges

Sensing material thickness is highly useful, as it is not uncommon for materials (especially natural materials such as plywood) to not match their specified thickness. The present invention therefore generally determines the actual thickness of the sheet of material at hand before cutting, applies this to be model (e.g., represented as a cutplan), and then produces the model, which now comes out in higher quality, as finger lengths etc. match up with the materials.

Different embodiments use different approaches to sensing the material thickness. One class of embodiments senses the distance from “above”, such as from the laser head or from the top of the cutting volume, and by subtracting this distance from the distance to the inset in the cutting volume obtains the material thickness. This class of embodiments is thus similar to the engraving gauges in that these gauges deploy sensors capable to sensing depth (see above). Another class of embodiments (cuts the material) and observes it largely from the side, e.g., using a camera or similar, allowing it to observe thickness directly (e.g., with directional lighting to produce contrast, take image, threshold image, segment image, e.g., using connected components, measure thickness directly or surface of component divided by width, or increase erosion until remaining surface drops below some threshold epsilon).

Materials may be of inhomogeneous thickness. Some material thickness gauges may therefor take multiple samples. The placement of these samples may be placed where they impact the model less, e.g., along the edge of the material, or fit into natural gaps in the cutting plan, as placed by the nester.

### 8.10 Materials Gauges

Material gauges are different from the gauges listed above in that many gauges do not cut the material, but often simply observe it.

Most embodiments consider material recognition a classification problem. While some embodiments may try to classify a material in the void, most embodiments will obtain better results by narrowing down the set of candidates, i.e., by answering the question “out of this given set of candidate materials, which candidate material resembles the observed material most.”

The classification generally consists of two main steps: (1) feature extraction and (2) classification.

For feature extraction some embodiments employ optical sensors (e.g., mounted to the laser head or mounted stationary in the cutter), such as cameras, then extract one of more aspects of color (e.g., hue, saturation, and/or value or similar) as well as texture features, such as image frequencies, visual features, etc. Alternatively, speckle sensing can be used to produce additional features (sensi-cut [Mustafa Doga Dogan et al. SensiCut: Material-Aware Laser Cutting Using Speckle Sensing and Deep Learning, In Proc. UIST '21. 24-38]). Other sources of features include, but are not limited to microphones combinations listening to the material's response to a frequency sweep by a speaker attached the material or by a prong tapping the material, and so on.

Based on the features extracted above, classification can be performed. While it is possible to do so by hand, most embodiments will choose to perform this using one of many applicable machine learning techniques, ranging from k-nearest neighbor to deep neural networks and anything in between.

Multi-layer material gauges classify multi-layer/sandwich materials, such as foamcore. One way of doing so is by observing the material from the side (as discussed above) or by cutting dips or depth gradients into the material, and then observe the individual layers from above.

### 9 Kerf Gauges

When laser cutting 3D models, precision plays a central role. The reason is that 3D models consist of multiple parts, held together by joints-most commonly intersecting slits called cross joints or interlocking fingers called box joints. To allow joints to hold without glue, parts are designed to overlap by a tiny amount, such as 100 μm for certain types of wood. This allows users to assemble such press fits by forcing parts into each other, which causes the natural springiness of the material to hold the parts together. This is what requires precision, i.e., if dimensions are not precise within 100 μm, the resulting model, such as the lamp shown in FIG. 23e, may either be impossible to assemble or fall apart under tension.

However, reaching this precision is complicated by the fact that all dimensions are impacted by a second factor: laser cutters burn off a certain amount of material during cutting, the width of the removed material being known as kerf. In order to achieve a functional press fit, the dimensions of parts sent to the cutter thus need to first be made wider (or “dilated”) by the expected kerf in order to achieve the desired dimensions after kerf. This requires users to figure out kerf prior to cutting.

Unfortunately, determining kerf turns out to be a challenging process. Today's technology enthusiasts (aka makers) commonly determine kerf using the following four-step process: (a) They cut a specifically designed “kerf strip”, (b) remove the kerf strip from the cutter and insert a separate part of it into a number of matching openings, thereby identifying the opening that fits best. Users then read the kerf value from the associated scale (e.g., 50 μm steps) and enter it into the system. (c) Users then dilate the cutting plan by kerf, e.g., using a vector editing program or using specialized laser cutter modeling software, e.g., FlatFitFab [James McCrae, et. al. 2014. FlatFitFab: interactive modeling with planar sections. In Proc. UIST '14, 13-22] or Kyub [Patrick Baudisch, et. al. Kyub: A 3D Editor for Modeling Sturdy Laser-Cut Objects. In Proc. CHI '19. 1-12]) and, finally, (d) cut the actual model.

This process is rather imprecise with 50 μm steps in order to keep the size of the kerf strip feasible, time-consuming (about 5 min for 4 mm MDF on a Trotec Speedy 360 [https://www.troteclaser.com] using FlatFab [http://flatfab.com), and rather laborious in that it requires users to run the laser cutter twice instead of once. This user effort is compounded by the fact that the procedure must be repeated periodically, potentially for every single model, to account for variations in material, power, and speed settings, as well as for the wear of laser, air compressor, and lens [Uslan, I. CO2 laser cutting: Kerf width variation during cutting, In Proc. of the Institution of Mechanical Engineers, Part B: Journal of Engineering Manufacture, 219 (8), 571-577] [https://hackaday.io/project/164156-lp3d-a-fully-lasercut-kit-3d-printer] (see Section 6). Furthermore, worse than that, this 4-step process requires expertise, which raises the bar and commonly excludes non-expert users from laser cutting.

The present invention alleviates this problem by providing automated kerf gauges.

9.1 Kerf Gauges that Measure Kerf without Applying a Load

Some embodiments of kerf gauges assess kerf in the absence of a force. These can, for example, be useful when calibrating for parts that will not be subjected to forces during operation. One class of embodiments achieves this by cutting an appropriate swatch, which could be as simple as a line, and then observe and measure the resulting cut.

The sensor equipment and process for doing is very similar to the equipment and process used by cutting gauges and line engraving gages. Different embodiments may use different approaches to measure kerf. Some may observe the swatch's outline using one or more cameras observing the material (e.g., illuminated from the backside in order to highlight the cut), and run computer vision algorithms to extract the cut from the image, e.g., such as a connected components algorithm, then measure the thickness of that component as debated earlier. Yet other embodiment may observe the backside of the material (e.g., my propping the material up), process using computer vision algorithm, e.g., binarize image by thresholding, run connected components, read smaller dimension=width of segment that is the line. Yet other embodiments may observe (a small segment of) a cut from the measure the width of the cut.

Kerf commonly features a tapered shape (wider on top, narrower towards the bottom). Yet, it is most commonly handled as a single dimension. Consequently, a kerf gauge may have to condense the observed taper into a single dimension. Different embodiments may employ different approaches, each one expressing a different interpretation of kerf, such as measuring the narrowest passage, measuring at a specific height, such as the bottom, using statistical means, such as computing the mean or median width, and/or applying various offsets or an offset proportionally to the compliance of the material (e.g., to simulate deformation a load might cause, as would be the case when assembling parts using press-fit joints).

### 9.2 Kerf Gauge Under Load

Other embodiments of the instant invention aim at measuring kerf while a certain force is being applied, ideally the amount of force that reflects the intended use case. If, for example, two parts are supposed to be forced together in the form of press fit finger joints with the help of a rubber hammer, then a kerf gauge might want to measure kerf while a corresponding amount fore is being applied.

FIG. 23 shows one such embodiment, here attached to the head of a laser cutter (in this disclosure, we will refer to it as “Kerfmeter”). This class of embodiments consists of 5 elements (1) A two-part swatch, i.e., two parts to be forced into each other. In the figure below, these are the spiral swatch cut buy the laser and the remaining material outside the spiral. (2) An actuator that forces the parts together. In the figure below, this is the motor (here with gearbox). (3) If needed, some mechanism that transmits the actuator's force onto one or both parts. In the figure below, these are two prongs that reach into two openings in the spiral swatch. (4) Optionally, a mechanism that stabilizes the swatch and/or the material. In the figure below, that is a third prong stuck in a third opening outside the spiral swatch, as well as a coil spring that pushes the spiral swatch down. (5) A sensor that measures the effect of the actuator onto the two-part swatch. In the figure below, this is a (magnetic) encoder on top of the motor (other embodiments use cameras, strain gauges, etc. for this purpose.

Kerfmeter attaches to the head of a laser cutter. (a) When the user sends a model to the laser cutter. Kerfmeter intercepts the job, injects an automated calibration routine that starts by cutting what we call a spiral gauge, (b) inserts its pair of prongs into the spiral gauge, and rotates it until it jams. Kerfmeter reads the angle θ at which this takes place using an encoder. This angle indicates how much material the laser has removed, i.e., the laser's kerf. (c) Kerfmeter triggers the dilation of the model by kerf, and (d) proceeds to fabricate the model. (e) Its kerf-calibrated joints make the model loose enough to allow for comfortable assembly, yet can also tight enough to resist tension, such as when suspending the model.

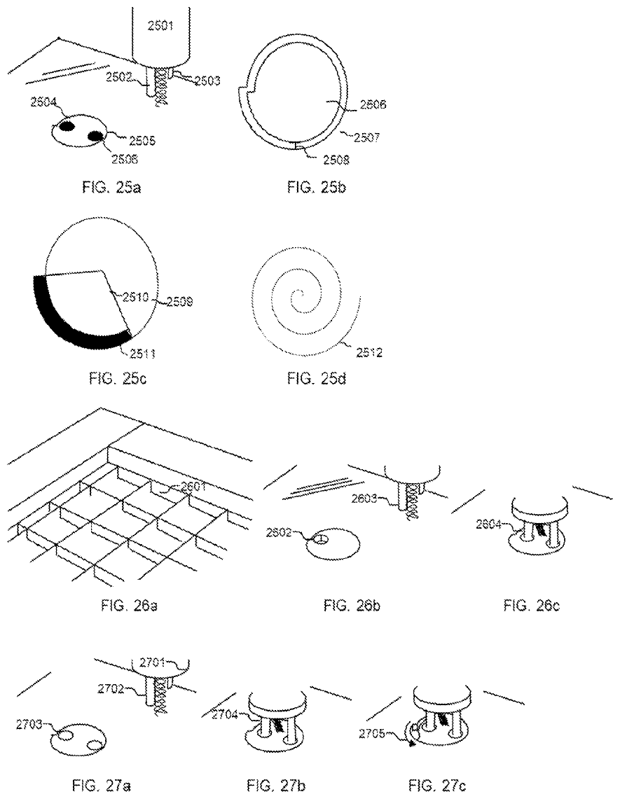

Kerfmeter consists of two components: first, a hardware component built into the laser cutter, which measures kerf, and second a software component, which acts as a server, controls the laser cutter, and dilates the cutting plan. Kerfmeter starts by the user sending a model to the cutter. This triggers the following automated seven-step process.
1. Material sheet: Kerfmeter pauses until users insert a sheet of material into the laser cutter. Users position the sheet flush against the stops that most laser cutters feature at the left and left top edges of their cutting area (FIG. 24). This will prevent the material from rotating when a force is applied (see Step 5 below). In case the material is warped, users flatten it out by placing a weight on it, keeping the material in focus and the Kerfmeter's spiral gauge cutout aligned with its perimeter (see Step 5 below).
2. Spiral gauge: As shown in FIG. 25a, Kerfmeter's hardware device now becomes active. It starts cutting what we call a spiral gauge, This gauge is the key element of our overall design, and its purpose is to make kerf “visible” to a rotary encoder. (b) Like everything cut using the laser cutter, the spiral gauge is subject to kerf, but the secret of its specific shape is that (c) rotating the spiral (counterclockwise) produces the same effect as growing it in place. Later (see step 5), we will use this property to measure kerf, as the amount of rotation a specific spiral gauge permits, here shown as θ, indicates the size of the gap around, i.e., kerf. (d) To make this work, we gave the spiral gauge the shape of the outermost revolution of a self-similar spiral, also known as an Archimedean spiral [https://en.wikipedia.org/wiki/Archimedean_spiral].
3. Holes: Eventually, Kerfmeter will spin the spiral gauge using a pair of prongs (see Step 5). In order to allow the prongs to grip the spiral gauge, Kerfmeter cuts a pair of holes into it. As illustrated in FIG. 26, Kerfmeter positions the spiral gauge so as to locate the holes over openings in the laser cutter's grating; this allows the round pieces of residue to drop through the grating, clearing the way for the prongs.
4. Inserting prongs: Kerfmeter now inserts the two prongs into the holes and, as illustrated by FIG. 27a, Kerfmeter orients the prongs so as to match the holes in the gauge, (b) moves the laser head so as to align the two prongs with the holes, and then (c) raises the worktable of the laser cutter so as to just barely stay clear of the grating.
5. Measuring kerf: As shown in FIG. 27c. Kerfmeter now conducts the actual kerf measurement. By gradually increasing the torque of the DC motor, it causes the spiral inset to rotate-until it eventually jams. During the procedure, Kerfmeter controls the motor's torque so that the pressure of the spiral inset against its surrounding matches the pressure between fingers when assembling box joints (see Section 9.3 for the underlying math). Throughout the procedure, Kerfmeter continually reads the rotary encoder attached to its DC motor and stores pairs of applied torque and resulting gauge angles, as measured by the encoder.
6. Dilating & fabricating the model: The Kerfmeter software now translates gauge angles into kerf as described in Section 9.3, dilates the model's cutting plan by that kerf, and sends it to the cutter. Our specific implementation of Kerfmeter accomplishes the dilation by asking the modeling software that produced the model (Kyub [Patrick Baudisch, et. al. Kyub: A 3D Editor for Modeling Sturdy Laser-Cut Objects. In Proc. CHI '19. 1-12]) to re-export with the additional kerf. Alternatively, models represented in appropriately extended SVG formats, such as MetaSVG [Nur Yildirim, et al. MetaSVG: A Portable Exchange Format for Adaptable Laser Cutting Plans. In Proc. Graphics Interface 2022] or laserSVG [https://github.com/florianheller/lasersvg], allow dilation directly, as they already contain surface information. For models represented in legacy SVG, the surfaces can be inferred as described in [Thijs Roumen et al., Assembler3: 3D Reconstruction of Laser-Cut Models. In Proc. CHI '21. 1-11].
7. Assembly: Users then retrieve the laser-cut parts from the cutter and assemble the model. Since kerf has now been properly accounted for, the model's joints hold together with just the right amount of force to allow a human user to assemble the model comfortably, while its joints also hold together (see Section 9.3). In FIG. 23e, for example, kerf calibration through Kerfmeter allows the lamp to hold up when suspended by a plate held by press-fit box joints.

### 9.3 Design and Engineering Behind Kerfmeter

We now explain the engineering requirements, the underlying technology, the geometry, and the math.

### 9.3.1 Hardware

FIG. 28a shows one possible embodiment of Kerfmeter. It is based on a DC motor 2804 (such as a Maxon DCX22S) optionally fitted with an appropriate gearbox (such as a Maxon GPX22 C 21:1 planetary gearbox) as well as a magnetic encoder (AMS AS5048A) 2803. A mount (here a universal aluminum mounting hub) attached to the motor's shaft holds the two prongs 2805, here implemented in the form of two bolts. A downward-facing coil spring 2806 mounted to the hub keeps assures physical contact between the spiral inset and the material surrounding it. The encoder is connected to a microcontroller 2807 (such as an ESP32), which drives the motor with the help of a motor driver 2802 (such as a Pololu G2).

The microcontroller communicates with Kerfmeter server through a serial connection over USB. FIG. 28b shows how serial and power cables going to and from the Kerfmeter device 2807 may be run through the drag chain of the laser cutter.

### 9.3.2 Alternative Embodiments

Error! Reference source not found. Error! Reference source not found, illustrates the space of alternative embodiments. While this disclosure, for consistency reasons, focuses on the specific embodiment shown at the very right (which we refer to as Kerfmeter in this disclosure), all of these embodiments are kerf gauges and considered part of the invention.

(a) Embodiments that do not apply a load can be implemented using a contactless sensor, such as a camera, a range finger, etc. (b) We achieve embodiments that measure in the presence of a force (e.g., the amount of force exchanged at the interface of a joint) by applying a force of appropriate magnitude during measurement. This can be accomplished using a range of devices, such as devices targeting a compressed gas or liquid at the contact surface or push a solid against it, etc. (c) We can do so using a device that applies a compression between or tension largely perpendicular to 2901 the involved surfaces, e.g., using 2902 a micrometer or calipers or similar. (d) Alternatively, we may apply a force largely tangential to the involved surfaces, e.g., as a way to more adequately represent the type of movement and force exchanged when assembling certain types of joints, such as box joints. (e) Some embodiments produce one single type of swatch simulating some sort of joint, such as 2903 a box joint of finger joint and measure the force required in order to assemble this one. In contrast, (f) other embodiments use parts at least one of which features a wedge shape, so that sweeping a range of forces, allows measuring the mapping between force and displacement. This approach helps extract the forces emerging at cross joints, at box joints, after the fact.

(g) Some embodiments insert a 2904 (e.g., reusable) wedge (e.g., made from a piece of the material, but more commonly from a hard material, such as steep or ceramics, etc.) into a cutout from above. Some of these require placing the 2906 opening in the material over an 2907 opening in the grating, so as to allow 2905 the wedge to be inserted more deeply. This approach is particularly useful when for calibrating the insertion of objects, such as motors, rods, etc. into the material (in which case, fidelity can be increased by making the wedge from the material of that object to be inserted—or the wedge may simple be (a copy of) the object to be inserted; for objects with a specific insertion mechanism, such as screws or bolts, 2908 a corresponding insertion mechanism may be used). (h) Other embodiments fabricate both halves of a joint, which is achieved most easily by fabricating 2909 both halves “in-plane”. This approach allows measuring the relationship between two pieces of the material, which is one approach to representing joints (such as box joint and cross joints etc.) in high fidelity. Fabricating in plane also reduced the risk of accidentally pulling the material sheet upwards upon release.

(i) Within the plane, different embodiment may employ different types of movement so as to insert one part into the other, such as a “cartesian approach” of sliding one part linearly into the other. Such a force can be produced using a range of mechanisms, including (assuming strong enough) the gantry of the laser cutter itself. (j) Other embodiments use a rotary movement, which can be produced, e.g., using (geared) motors.

(k) The 2910 resulting design is subject to a horizontal net force upon release. (l) Some embodiments may cancel this force out by using a 2911 second (or more) mechanisms that operate in opposite directions. (m) Some embodiments may opt for an 2910 incline/wedge shape, which allows obtaining a mapping by means of performing a sweep; it also offers a mechanical advantage. (n) Some embodiments may choose to produce an interface between the two parts that forms an edge, which can be accomplished with a wide range of shapes (o) Other embodiments, may choose to produce a surface as interface, e.g., so as to resemble the spatial relationship between the parts of a box joint or cross joint. For the spiral design, for example, this can be accomplished using an 3001 Archimedean spiral.

### 9.3.3 Software

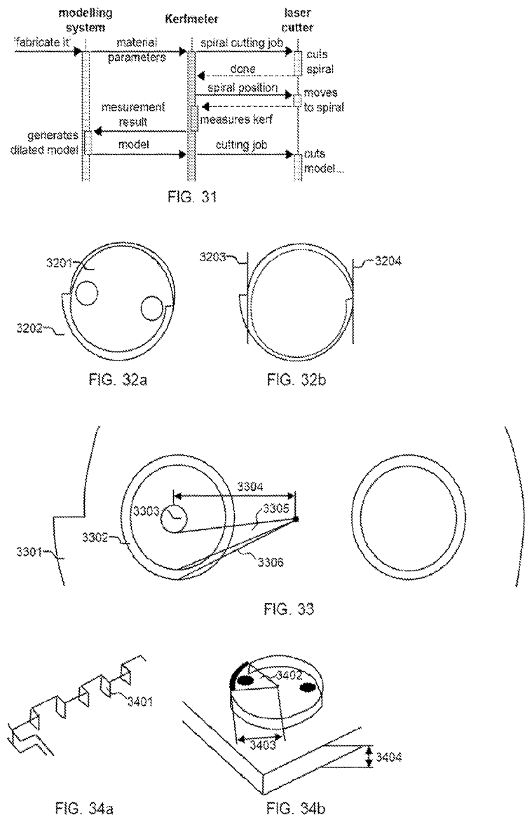

When operated stand-alone, the Kerfmeter server software, which is running on a computer connected to the laser cutter via serial over USB, talks to the modeling software (in the case of our prototype, this is kyub [Patrick Baudisch, et. al. Kyub: A 3D Editor for Modeling Sturdy Laser-Cut Objects. In Proc. CHI '19. 1-12]), and the laser cutter driver (in the case of our prototype Trotec Ruby [https://www.troteclaser.com/en/laser-machines/laser-software]), as illustrated by FIG. 31.

When the user exports a model in the modeling software (in our case kyub [Patrick Baudisch, et. al. Kyub: A 3D Editor for Modeling Sturdy Laser-Cut Objects. In Proc. CHI '19. 1-12]), the modeling software sends information about the material thickness and the desired assembly force to the Kerfmeter server via a WebSocket connection. The Kerfmeter server responds by sending the material information to the laser cutter's REST API. It then sends a vector drawing of the spiral gauge to the laser cutter, which starts fabricating it.

As discussed earlier, when the spiral and holes have been cut, the Kerfmeter server positions the laser head over the spiral shape and programmatically raises the cutting table by sending the according move commands to the laser cutter REST API to insert the prongs into the holes in the spiral inset. It then sends the start command with the specified force and finger length to the Kerfmeter device via the serial connection.

The Kerfmeter device continuously reads the encoder, adjusts the target torque, and finally reports force and rotation angle pairs back to the Kerfmeter server, allowing it to calculate kerf, which it sends back to the modeling software through the WebSocket connection, which in turn triggers the dilation of the cutting plan. Finally, this cutting plan gets sent to the Kerfmeter server, which forwards it to the laser cutter, where it gets fabricated.

Kerfmeter provides this functionality by means of an application-independent API that offers three calls: run_kerfmeter( ) actuates the spiral gauge, get_kerf_value( ) retrieves the measured kerf value, and reset_kerfmeter( ) resets kerfmeter to its zero position. All functions are implemented as python scripts using the simple_rpc library [https://github.com/jfjlaros/arduino-simple-rpc]. These three API calls allow integrating Kerfmeter into arbitrary laser cutting design systems, such as flatFab or Onshape, as well as kyub.

### 9.3.4 Translating Between Rotation and Kerf

As mentioned earlier, the spiral type that archives the desired self-similarity is an Archimedean spiral [Archimedean spiral. https://en.wikipedia.org/wiki/Archimedean_spiral. Accessed September 2022]. Its curve is described by the polar equation r=b·φ+a where r is the radius of the spiral, b is the distance between loops, and a is the distance from the center to the start of the spiral. φ defines the angle of rotation for each point on the curve. We represent all angles in degrees throughout this disclosure. Rotating the spiral inset causes it to “grow” based on the formula kerf=b·θ where θ is the rotation angle, as measured by Kerfmeter's encoder. We determine the spiral parameter b as b=maxKerf/maxRotation Using a manual kerf gauge, we empirically determined kerf values on our cutter to lay well below maxKerf=430 μm in wood and MDF materials (in our Trotec 360). Note that proper maxKerf highly depends on the lens, and laser power of given laser cutters. Once maxKerf is known, any laser cutter can use this spiral gauge by changing the parameter b. The inset of the spiral geometrically disengages like FIG. 32a, once the tangent line at the endpoint of the inner spiral (FIG. 32b. 3204) is parallel to the tangent line at the starting point of the outer counterpart (FIG. 32b, 3203), which is reached at 180 degrees rotation. However, the inner spiral can also overcome the outer spiral by compressing the material holding it in place earlier. Based on our experiments, rotating the inner spiral up to 155/180 did not cause the inner spiral to disengage. Applying maxKerf/maxRotation gives us an b of 2.774 μm, the value throughout this disclosure.

### 9.3.5 Compensating for the Hole Kerf

The two holes on the spiral gauge are also subject to kerf, allowing the motor and encoder to rotate before engaging the spiral inset. FIG. 33 illustrates the geometry of the problem at hand: Aₕ denotes the angle between the outline of the prong and the hole's theoretical outline, while Aₕₖ denotes the angle between the theoretical outline of the hole and the outline of the hole, e.g., the additional rotation introduced by kerf. Without compensation for this, we would for kerf values from 100 μm to 300 μm introduce an error of 14 μm to 17 μm by not correcting.

Our Kerfmeter software compensates for this error by solving the following recurrence:

$$kerf = {kerf}^{′} - a \cdot ( {A}_{h} + arctan \frac{{kerf}^{′}}{2 R} )$$

where a is the spiral constant, and kerf′ is the result of the previously calculated kerf value.

### 9.3.6 Translating Between Forces and Torque

Finally, the Kerfmeter workflow from Section 2 requires translating back and forth between the motor torque t applied to the spiral gauge and the force F required to assemble box joints. This conversion is governed by F=μP_{E}A_{J} [https://www.meadinfo.org/2009/07/press-fit-pressure-calculator-optimize.html], where μ is the coefficient of friction of the given material and P_{E} is the pressure between joint and joint, which depends on the material's Young's modulus and strain, as well as the sum of the contact areas of the box joints A_{J}. FIG. 34a illustrates this contact area.

The torque τ is defined as τ=μP_{E} (2π−2θ)r²·L, where θ is the angle of rotation, r is the radius of the spiral gauge, and L is the material thickness, as illustrated by FIG. 34b, simplified by approximating the circumference of the spiral inset with a circle. Since both the box joints and the spiral are made from the same material and will cause the same strain, μP_{E} is the same. We obtain τ=(2π−2θ)(r²·L)F/A). The specified force F depends on torque τ and rotation angle θ. For the computation of the used torque, Kerfmeter uses the angle of rotation θ measured by the encoder after the torque overcomes the friction between the spiral and the table (FIG. 34b). For example, if a user wants to assembly three fingers of a box joint made from 4 mm thick material with 50N force, Kerfmeter needs to apply ˜0.62 Nm at an angle of 45 degrees, ˜0.41 Nm at an angle of 90 degrees or any other pair of τ and θ as described above.

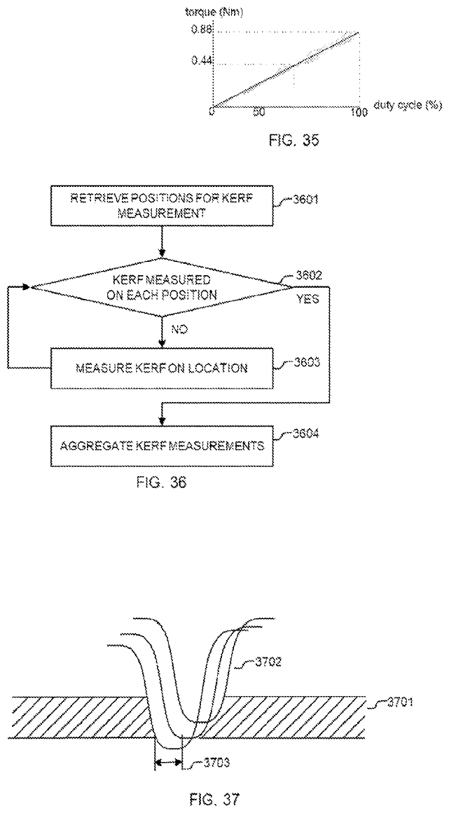

This model requires Kerfmeter to apply a well-controlled torque, which we produce by varying the length of the pulse-width modulation duty cycle. As illustrated in FIG. 35, we verified that the length of the duty cycle linearly affects our motor torque.

### 9.4 Calibrating Kerfmeter

The Kerfmeter device, as described above gives us a kerf value. However, kerf is just a means to an end—and that end is to calibrate engineering fit or simply “fit”. To apply Kerfmeter, we need to have a sense of what fit values we should be aiming for. In order to find out, we conducted a simple user study in which we had participants assemble box joints by forcing one part of the joint into its counterpart, which we had attached to a digital force gauge. We then measured how much force they were willing to apply. We found that all participant managed to assemble all box joints requiring about 100N of compression force. At the same time, someone skilled in the art would know that users are capable to applying much higher forces when hey use tools, such as a rubber hammer to drive parts together.

When picking what force to aim for, we need to consider that mechanical devices, including the gantry inside the laser cutter, support only a limited precision. This is also known as positioning accuracy or repeatability and it typically stated by the manufacturer. The Trotec Speedy 360 laser cutter, for example, offers a repeatability of +15 μm. Consumer devices, such as the laser cutters made by Glowforge offer repeatability substantially worse than this. On the other hand, there are specialized laser cutters that offer repeatability of around ±1 μm.

Some types of cutting tasks incur repeatability multiple times. When cutting a square, for example, the width of that square is subject of up to 2× repeatability: one for the left and one for the right edge, thus ±(15 sqrt(2) μm=±21.2 μm for the 95% confidence interval (assuming the repeatability of each edge to be statistically independent). When cutting box joints, repeatability can come into play up to four times. This gives the overlap, i.e., the aforementioned interference, ±30 μm for 95% confidence interval.

In the case the example of the Trotec laser cutter: (1) the repeatability of the gantry introduces a standard deviation of 10.6 μm as we measured the width of the rectangle. (2) This compounded with variability caused by the cutting location, i.e., an additional standard deviation of 13 μm (on the Trotec cutter; substantially worse on the two other cutters). (3) We now have a sense of the variation resulting from the machine alone (i.e., without any kerf strip or Kerfmeter): the machine produces a standard deviation of sqrt(10.6²+13²)=16.7 μm.

This number is non-trivial, as it is not too far from, for example, the 50 μm steps that form the basis of the kerf strip's scale [https://elplatt.com/laser-cutter-kerf-gauge]. This sets our expectations for kerf calibration: a highly precise laser cutter (for example, ExactCut 430 Coherent advertises repeatability of 1 μm) would allow us to aim for a specific fit; we might, for example, aim for maximum stability by setting the intended assembly force close to the human limit determined above.

However, the use of less specialized machines produces data that tells us that we need to be more conservative. Our primary objective has to be to stay within the interval of acceptable fit values in either direction: we neither want to run the risk of making a model impossible to assemble, nor do we want to run the risk of joints falling apart.

Some we should therefore aim for the center of the assembly force interval.

Note that this observation and the resulting strategy is only based on our analysis of laser cutter hardware. These insights therefore apply to any kerf strip to the same extent they apply to Kerfmeter.

Now that we have defined our strategy for picking a fit, we are ready to evaluate the performance of Kerfmeter.

### 9.5 Improving Kerf Precision

While specialized machines that offer one-micron repeatability are available, the more affordable machines used in fablabs, makerspaces, and most work places in industry, do not offer the repeatability required for making joints fit reliably.

Automated kerf measurement, however, can help.

### 9.5.1 by Taking Multiple Samples

Kerfmeter performs its task in fully automated fashion while also consuming substantially less material than the traditional kerf strips. This lowers the bar for performing multiple measurements. Some embodiments may choose to exploit this in order to increase the precision of the device further so as to surpass the precision of manual kerf measurement substantially, as repeated measuring allows us to counteract the limited repeatability of the cutter.

The fact that we can increase precision by measuring multiple times is based on the observation that limited repeatability hits precision twice: During calibration and during fabrication. In the worst case, repeatability errors in one direction during calibration and in the opposite direction during fabrication, allowing both errors to accumulate. We can reduce repeatability issues during calibration by running the calibration device multiple times.

Running Kerfmeter (or any kerf calibration tool for that matter) twice lowers the effect of limited repeatability by a factor of sqrt(2), i.e., from ±15.5 μm to ±11 μm. Sampling 3 times increase precision further to ±8.9 μm. Given that limited repeatability turned out to be the main limitation of kerf calibration, we feel multiple measurement are worth pursuing.

### 9.5.2 Improving Fit by Cutting in Multiple Passes

We hereby disclose another approach to reducing the negative effects of limited repeatability: cutting multiple times.

Cutting in multiple passes is a known technique in the laser cutting domain, but not for this purpose: Architectural model shops tend to laser cut cardboard in multiple (lower power) cuts in order to reduce the risk of burn marks. They also tend to laser cut polystyrene foamcore in multiple passes in order to reduce shrinkage of the foam layer. In the domain of optics and laser physics, double-pass cutting was found to produce higher-quality cut surfaces and less burning than single-pass cutting in glass-fiber-reinforced polymer material [Choudhury, I. A., and P. C. Chuan. “Experimental evaluation of laser cut quality of glass fibre reinforced plastic composite.” Optics and Lasers in Engineering 51.10 (2013): 1125-1132.]

We disclose a different process and use case: we found laser cutting in multiple passes, while widening kerf, to reduce the variance of kerf, thus combatting the effects of limited repeatability.

FIG. 37 illustrates the first of two embodiments. Some embodiments may choose to use configurations of speed×power×numberOfPasses where the product of “power” (i.e., energy per length of cut line) and numberOfPasses exceeds the “power” one would have used for a single cut.

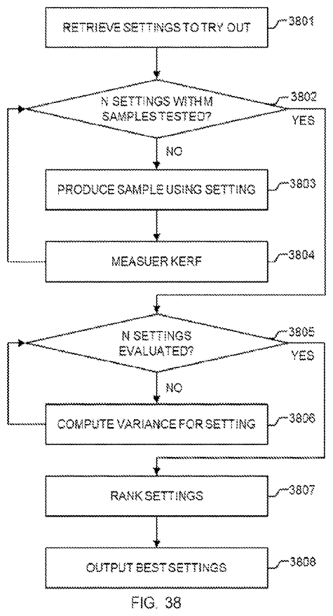

FIG. 38 shows one way of calibrating, i.e., of identifying speed×power×numberOfPasses configurations that produce kerf with the lowest variance. The resulting kerf can be measured using any kerf-measurement apparatus, including any form of Kerfmeter. 2501 The calibration routing may be run for a set of settings to be tried. Each setting consists of speed×power×numberOfPasses. 2502 The procedure then runs m samples each, 2503 produces a sample, 2504 measures its kerf and 2505 aggregates the results per setting in order to 2506 obtain the variance. 2507 The settings leading to the lowest variance are promising and 2508 should be considered further. Rather than testing the entire cross product of speed×power×numberOfPasses in one go, it may be more economical to “beam search” the problem, i.e., run a subset of settings, determine one or a few promising configurations, and then vary each of these in order to produce the next round of testing, and so on.

Even better results can be obtained using a closed-loop approach. In this approach, the 2601 system retrieves only the initial settings to 2602 produce the first set of samples and 2603 measures the kerf for these samples, calculates the variance between them and aggregates them. Until the 2605 variance is lower than a given threshold, the 2604 system derives settings for the next set of samples from the previously retrieved values. Once the set variance is met, 2606 the system outputs the settings with the lowest variance.

### 9.5.3 Compensating Kerf Based on Location in the Cutter

With the same reasoning, Kerfmeter makes it more feasible to measure kerf across cutting locations in the laser cutter. This allows us to compensate for variations in kerf across locations inside the cutter.

FIG. 40 shows the two parts of a process that enables non-uniform kerf compensation. The Systems retrieves locations for sampling, tests kerf at each location and aggregates the readings. In one embodiment this produces a single adjustment value for kerf. In a different embodiment this results in a spatial distribution of kerf inside the cutter space and/or across the material. In some embodiments the decoder uses this information to adjust the model.

### 10 Reusing Calibration Information

So far, we have been describing calibration processes based on samples of the actual material in the actual laser cutter, which one would generally expect to produce the most realistic results. However, some embodiments may also support calibration based on information obtained with different materials and/or on a different laser cutter.

In order to make use of calibration information obtained with different materials and/or on a different laser cutter, we apply a function that translates this information to the material and machine actually to be cut. Approaches include, but are not limited to: (a) translate the found sensor values into the sensor values one would have found had one tested with the actual material and then translate these to the adjustments of laser cutter settings and/or model adjustments necessary. Or (b) translate the found sensor values into adjustments of laser cutter settings and/or model adjustments necessary, or (c) translate the found sensor values and the properties of the material measured and the properties of the material actually to be cut directly into the adjustments of laser cutter settings and/or model adjustments necessary.

Some embodiments may perform these translations by hand and may compute the “similarity” between two sheets of material in various ways, such as, such as by computing the similarity between the feature vectors of each material (Error! Reference source not found), e.g., using the cosine measure [https://en.wikipedia.org/wiki/Cosine_similarity]).

Based on such a similarity metric, we can now predict calibration information by aggregating calibration information from one or more samples considered similar, typically weighted by their degree of similarity.

Some embodiments extend this approach further by also including a feature vector describing the laser cutter on which the sample was assessed. The resulting system, may now aggregate calibration information from similar materials on the current cutter with very similar materials on a somewhat similar cutter, etc. (e.g., by means of a centralized server or decentralized architecture, such as blockchain). The approach of considering calibration information obtained on other machines and thus likely by other users also helps bootstrap calibration.

Most embodiments, however, will instead perform the translation of calibration information using one of many applicable machine learning techniques, ranging from k-nearest neighbor to deep neural networks (DNN) and anything in between. To apply these methods, we train a system, with the calibration data obtained previously, such as in the form of the aforementioned feature vectors of each material, the features of the machine it was obtained on, and with the calibration data this configuration produced. We then query the system with the feature vector of the material at hand and the laser cutter at hand.

If a prediction made by any of the methods described above is well supported (e.g., large number of samples considered, small variance between samples) a calibration system (e.g., the gauge manager) may decide to forego an actual calibration with physical material and instead run with the predicted information. If a prediction is less well supported, systems may decide to still run a physical calibration process, albeit limiting it to a smaller set of settings centered around the predicted values.

### 10.1 Fallback Calibration

Finally, as fallback some embodiments may support even less fortunate configurations, such as:
1. Calibration with a different and unknown material: Run the calibration mechanisms described above, but limit the analysis to determining the factors that are still possible, such as focus, positioning of the gantry, repeatability, some basic estimates of kerf, etc.
2. Calibration of the cutter without material: Run calibration mechanisms that do not involve actual processing of material (such as cutting, engraving, marking), but measure the state of the laser cutter in isolation, such as determining laser intensity based on a calorimeter or similar, monitor wear of laser source based on usage time, focus, positioning of the gantry, repeatability, speckle, monitor the wear of the lens using a camera, and so on.
3. Calibration of the material on a different laser cutter: Run a calibration process as before. Then apply a function that translates these to the laser cutter actually to be used.
4. Calibration without laser cutter: Run an analysis of the material without processing the material using the actual machine (such as cutting, engraving, marking), such as by applying various other tools, such as observe using a camera, measure its response to a bending moment, measure stiffness, measure thickness, and so on.

### 11 Material Handling

Ultimately, i.e., upon fabrication, a model has to be mapped to an actual “sheet of material” (see “nesting”).

We use the following nomenclature. Sheet: a specific physical piece of material. Commonly rectangular, but could be any shape. Commonly flat, but, e.g., in the case of a 5-axis or 7-axis fabrication machine could be any 3D shape. Sheets may be unused in which case they bear their original shape or they may be partially used, in which case they bear one or more cutouts, e.g., from where parts for earlier models have been fabricated. Batch: sheets may have been acquired individually or as part of a batch. Material: all sheets of the same formal specification by the same manufacturer, such as “8 mm, 5-layer birch, manufactured by vendor X”. Class of materials: all sheets of the same formal specification.

### 11.1 Assign Actual Sheets of Material to Models at Design Time

In some cases, users may assign an actual piece of material already while designing a model. This makes sense, for example for artists, who might consider the specific texture of the material as essential for their art piece. They may also pick the actual portion and orientation of a piece of material for that matter.

Some embodiments may allow users to pick such as a piece of material in the physical world and then make it show up in the application subsystem (e.g., by scanning it, see below) and/or allow users to pick out a piece of material in the virtual world and then help them locate it in the physical world (using markers, see below).

11.2 Replace Actual Sheets of Material with Other Sheets of Material

When another copy of this object is being fabricated, by the same user or by a different user. e.g., by sharing, e.g., on the Internet, the original piece may have been used up, so a different piece has to be picked.

Some embodiments may therefore offer substitutes, typically a close match according to some similarity metric, such as (a) another section of the same sheet of material, (b) another sheet from the same batch, (c) a sheet from another batch of the same type by the same vendor, (d) a batch of the same type from a similar vendor, or (e) a sheet from a similar batch from the same vendor, (f) a sheet from a similar batch from a different vendor, and so on . . . up to (g) a completely different material.

Systems may compute the “similarity” between two sheets of material in various ways, such as, such as by computing the similarity between the feature vectors of each material, e.g., using the cosine measure [https://en.wikipedia.org/wiki/Cosine_similarity]). This matching can be further improved by assigning each feature a weight reflecting the importance of that feature in the context of use in the model at hand.

Other embodiments may compute similarity between material sheets in two steps: First replace actual sheets with “classes of materials” (see below) that express the purpose performed by the sheet in its context in this model. And then, e.g., upon fabrication, translate that “class of materials” back into (different) actual sheets.

### 11.3 Alternatively, Users May Choose a “Class of Materials” at Design Time

In other scenarios, users may just want to give their models or individual parts of their models some specific functionality (which could then be fulfilled later by a range of different actual sheets). Application programs may therefore allow users to assign a “class of materials”. A class of materials is essentially a query that different actual sheets match to different extents. Examples for classes of materials include “birch”, “birch 8 mm”, “8 mm”, “plywood”, “3 layer”, and so on and/or may also describe qualities material are supposed to offer, such as (a) a specific optical quality, e.g., clear acrylic to form cover of a box the contents of which is supposed to be visible from the outside or frosted acrylic covering a set of LEDs in order to form a diffuser, (b) a specific acoustic quality, e.g., by picking solid spruce for the soundboard of their guitar or Okume plywood for the tapa of their cajon, or (c) a specific structural quality, e.g., by picking 8 mm marine plywood for the seat of a chair, (d) specific weight, e.g., by picking foamcore for an airplane model. (e) compliance, e.g., to make a make a unicorn model with rounded surfaces, (f) foldability, e.g., to form hinges for a compliant mechanism, (g) water resistance, e.g., acrylic for a boat, (g) heat conductivity, (h) electric conductivity, (i) a specific look, such as to create a red plastic box, (j) price, and so on.

Classes of materials are a way for the designer of a model to express that not only one specific material or sheet is acceptable, but that a number of materials sharing some attributes might be suitable. One might thus say that picking a class of materials conveys (1) information about (some aspects of) the desired material as well as (2) a rudimentary “weight function” describing the intended purpose in that a criterion, such as “5-layer” may either be in the class definition, making it relevant, or outside of it.

Specifying a less specific class of materials declares more actual materials as appropriate, thus makes it easier for the system or users to locate appropriate materials when fabricating the model. This tends to be appreciated especially when sharing models. Also, since the (class of) material names are inherently shorter, it allows for a simpler and “friendlier” user interface, especially suitable for non-expert users.

FIG. 42 shows an example user interface, i.e., a menu that offers a selection of such “classes of materials” to a user. Such menus can be used to offer predefined classes of materials, actual sheets, or both. Alternative user interfaces include search box and query constructors, etc. With an actual material or a class of materials selected, user may apply their choice to their of the model 5403 or to individual faces (e.g., by clicking on the faces, etc.).

### 11.4 Mapping an Actual Sheet to a Model

Actual materials may either by picked by users who then have to inform the system about their choice (so the system can map the model to it), or by the system, which may then want to inform the user about its choice (so that the user can place the correct sheet into cutter).

Different embodiments may employ different workflows to allow users to pick materials:

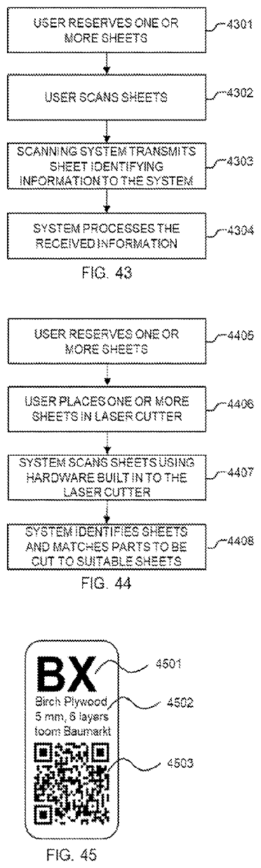

(1) Early physical possession: before starting the fabrication process, users may gain physical possession of (a superset of) the sheets they consider using. The workflow shown in FIG. 43 describes the process of registering their possession of these sheets with the system.

Users start by reserving one or more sheets 5201. Users may do so by taking physical possession, (e.g., taking these sheets to a dedicated location), by marking the sheets (e.g., by applying a sticker, a post-it note, etc.), by simply informing others that they have reserved these sheets, or, in cases where there is no ambiguity in the first place, by doing nothing.

At some point in time, users may then register the reserved sheets with the system 5202. They may do so by scanning the sheets using a device capable of registering information, e.g., by using a specialized app or website on a mobile phone. Information gathered in this process is transferred to the system as described in 5203.

Alternatively, users may scan using a generic scanner, such as a generic QR code scanner or camera app on a mobile device. This may trigger an action (e.g., opening a specialized website or app, invoking an API call etc.), processing and transferring the given information as described in 5203. Alternatively, the user may enter the information decoded by the generic scanner, or information gained in any other way (e.g., a sheet ID contained on an attached marker as exemplified 5101 manually into the system (e.g., by using a search interface or by filling out a form, etc.).

In all embodiments in which the user is not already logged in when the sheet ID is provided to the system, users may provide their user identity retroactively or during the scanning process by, e.g., logging in during or after scanning, selecting their identity from a list of users, using a code with potential temporal validity retrieved on a device where they are already logged in, or allowing logged-in users to attach their identity to sheets reserved for an unknown user. The system may also be able to identify the user without additional interaction, e.g., by utilizing device identifying information (e.g., MAC address) to match the scanning device with a device previously attached to a specific user.

The scanning system now transmits the sheet IDs to the application subsystem 5203, directly or by means of the laser cutter subsystem or any piece of other information processing software capable of forwarding information. Any system may include additional information including, but not limited to, the location, the time, or the IP address of the device. If the user ID was known at scanning time it may or may not be transmitted together with the sheet IDs.

The application subsystem processes the received information 5204. It may mark the sheets identified as being reserved, possibly adding additional information such as the reserving user if it is present. Alternatively, the incoming data may be processed with or without storing it prior or after additional processing steps. Additional processing may include but is not limited to modifications to other data in the system (e.g., updating the sheets' location based on location data included in the received metadata), or determining a potentially unknown user's identity utilizing the metadata.

(2) Scan in the laser cutter: in this embodiment, the sheets used during fabrication remain vague including the moment when the fabrication job reaches the laser cutter. Users may take possession of one or more actual sheets of material and place them into the cutter (before or after sending the model to the laser cutter). The laser cutter subsystem then identifies the sheets as described below.

If the model lists this particular sheet as its material the system may proceed to cut. If the model lists a class of materials that matches the actual material at hand, the system may replace the class of materials in the model with the actual sheet hand and then proceed to cut. If the material lists a different actual sheet of material or a class of materials that does not match closely enough, the laser cutter subsystem may alert the user.

The system may identify sheets of materials using various methods, including, but not limited to the following:
(1) Based on markers: a person who is able to identify a sheet of material in the first place. e.g., by ordering it, may persist this knowledge by printing a (human- or machine-readable) marker such as a QR code and attach it to the individual sheets. This user may also link the ID to the purchase information which allows accessing the type of information manufacturer typically provide, such as “8 mm, 5-layer birch plywood.” Once a sheet bears a marker it can be identified by pointing an appropriate reader at it.
(2) Based on its appearance: especially for sheets not bearing a marker, sheets may be identified based on their visual appearance including color, stiffness, weight, and so on. Partially used sheets tend to feature particular cut-out pattern in addition. All these allow matching sheets to sheets recorded in the system by taking a picture and then matching with candidates in the system using computer vision, such as SIFT or template matching, etc.

### 11.5 Locating a Sheet Picked by the System

If a model listing a particular sheet as its material is sent to the laser cutter the laser cutter subsystem may request the user to provide this particular sheet. To simplify the user's job of locating the sheet, the system may provide the user with a description of the desired sheet, such as “birch 8 mm 5-layer”. This information may be sent to the user by the application subsystem, by the laser cutter subsystem directly on build-in or connected displays or leveraging the user's computing infrastructure, e.g., by sending a text message to the user. Once the user inserts the correct sheet(s) into the laser cutter the fabrication process may start (automatically or after manual confirmation).

FIG. 45 shows a way of helping users locate a specific sheet of material, i.e., by extending markers attached to material sheets with human-readable IDs. It includes what we call a reverse look-up ID 5101, a short code (two characters in the shown example), preferably shown in a visible way (here shown in large font). Other embodiments may use numbers or icons or similar. In order to allow for such a short code, this code is designed to unique only within a smaller scope, such as within the location/lab. To keep codes short, codes may optionally be reused, once the sheet that previously used the code is known to have not be in use anymore (e.g., by having been used up). Additionally, the shown marker also contains human-readable information 5102 about the sheet's material as well as a machine-readable code 5103, which can include uniquely identifying information about the sheet, but may also only include less restricting information.

Similarly, when sending a model using a class of materials off to a laser cutter subsystem, the system may map classes of materials to actual sheets, in which case users will again then be asked to locate these sheets as described above.

### 11.6 Mapping Classes of Material to Actual Sheets

As an alternative to letting the system map the classes of materials in a model to actual sheets, users may manually map classes of materials to actuals sheets of material. Manual mapping can be useful, especially when mapping part that perform a specific function in the model at hand. A piece of frosted acrylic, may, for example, act as an optical diffuser or as a soundboard or tapa in a cajon. In the first case, it may best be replaced with paper, in the second with clear acrylic. Since an automated system may be oblivious to this hidden logic, manual mapping might be useful.

FIG. 46 shows one possible user interface that allows users to perform this mapping. The interface lists the classes of materials 5001, 5002 . . . contained in the model. When users select one such class of materials 5002, the computes the similarity metric between all sheets of materials available to the user and use this information to produce a ranked list of such sheets, with the best matches in a preferred position, such as on top of the last.

Some embodiments may provide additional ways of selecting actual sheets for display, such as by promoting sheets of material to the top of the list when the actual physical sheet gets scanned.

### 11.7 Nesting

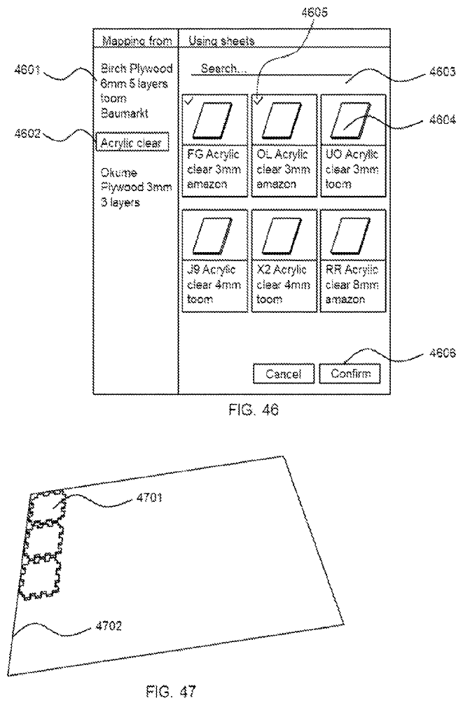

Once a model has been mapped to one or more actual sheets of material, the actual size and shape of the sheets has been defined. Next, the user and/or the system may want to arrange the parts that form the model onto these sheets. Different embodiments may optimally apply a layout strategy (such as roadkill [Abdullah et al. Roadkill: Nesting Laser-Cut Objects for Fast Assembly. In Proc. UIST '21, 972-984]). Users may then choose to nest automatically (e.g., using SVGnest). Or manually, such as using a direct manipulation as shown in FIG. 47, which allows users to place model parts 4701 onto (a scan of) an actual sheet of material 4702.

### 12 Real-Time Calibration & Closed-Loop Control

While the calibration apparatus presented so far used two distinct phases (calibration und then fabrication of the model) some embodiments may choose to perform calibration while fabricating the model.

The main idea is to at least initially produce all effects using a multi-pass process that starts with too weak an effect (cutting does not go all the way through, engraving too shallow, marking too faint, cutouts too small, and so on) but then obtain the desired effect size by means of additional passes that wither pile onto what is already there (cut on top of a cut already there, engrave on top of the already existing engraving, mark on top of the already existing mark) or replace with a larger version (place a dilated cut out onto the cutout already there).

In order not to avoid damaging the model in the process, such a calibration real-time calibration procedure will generally want to act in a risk-averse fashion (1) initialization of parameters based on risk-averse estimate, i.e., one that might produce “too little” of an effect, but does not produce “too much” of an effect. (2) fabricate an element that is part of the model. (3) sense: Use sensors, e.g., built into the machine, to verify whether the effect size falls into the acceptable range for this parameter. (4) Decide: If the value is below the acceptable range for this parameter, (5) Increment: Based on the size of the sensed effect, compute the increment as conservatively estimate the correct value minus the value already performed-so that the combined effect is expected to land in or below the target range, and go back to step (2). (6) Replacement: if the algorithm ever accidentally overshot, the algorithm discards that part (it may optionally indicate this visibly to users, e.g., by marking the part or cutting it up), locate a previously unused area of material and create a new copy with lower settings.

Another embodiment of this approach is to start by performing a regular calibration phase as presented earlier, but still monitor the fabrication progress as it unfolds using one or more sensors and respond when necessary for closed-loop control. The response may include (a) an immediate repair or replacement and (b) an adjustment of settings so as to reduce the risk of the issue repeating itself.

Different embodiments may monitor different aspects, such as (1) a system may respond to detecting burning by replacing burnt parts or by taking measures to stop burning before it exceeds the threshold for acceptable burn marks, such as by pausing the cutting process to allow the material to cool down, dispensing moisture. The system may then switch to a process less prone to burning, such as multi-pass cutting, adjust ventilation, etc. (2) A system may respond to detecting material not being cut through by repairing the incomplete cut with an additional pass, then increase power, lower speed, or increase the number of passes, etc. (3) Similarly, a system may respond to detecting engravings that are too deep or not deep enough, markings that are too dark or not dark enough, and so on.

FIG. 1: Example of a press-fit mechanisms, here two plates joined by a box joint in order to form an angle.

FIG. 2: Flowchart illustrating overall calibration workflow.

FIG. 3: The components that form one possible embodiment of the presented system

FIG. 4: Flowchart describing the workflow of running and evaluating gauges.

FIG. 5: Achieving kerf correction using a global correction

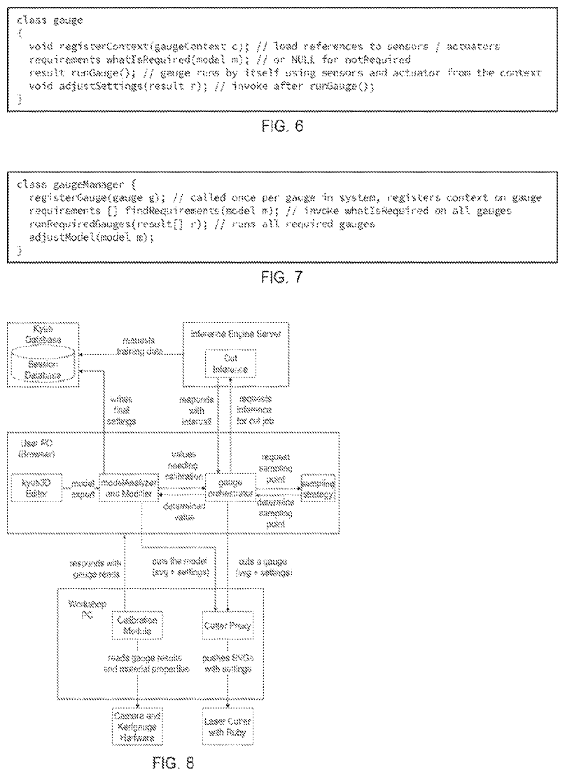

FIG. 6: Signature of the gauge class that is used to encapsulate a step in the calibration

FIG. 7: Signature of the gaugeManager class that is used to coordinate all gauges in the system and brings them together with their hardware requirements.

FIG. 8 System Overview of “Dumb Laser Cutter”

FIG. 9: Example model illustrating the limitation of point-based formats.

FIG. 10: Example of a cutplan that produces a 25×25 mm square plate

FIG. 11: Two representations of a plate with box joints that behave differently when the mating plate changes its thickness.

FIG. 12: Example of a cutplan for two plates joint with box joints

FIG. 13: This cup is an example of a model, where an adjustment of material thickness might require growing inwards or outwards.

FIG. 14: Flowchart of decoder for model files

FIG. 15: Flowchart of how the system extracts the features it needs to calibrate

FIG. 16: Flowchart of cutplan encoder

FIG. 17: Flowchart gauge based on cutting material.

FIG. 18: Flowchart showing a process gauges may use to locate optimal settings

FIG. 19: (a) detail camera, (b) wide-angle camera (b) vertical range finder, (d) custom tools, here kerf tool.

FIG. 20: Cutting swatches over a grating

FIG. 21: Flowchart for calibrating cut energy.

FIG. 22: Flowchart of the greyscale marking calibration.

FIG. 23: Example of a stand-alone deployment of Kerfmeter

FIG. 24: Alignment aids of the laser cutter to prevent the material from rotating during operation.

FIG. 25: (a) Kerfmeter cutting its spiral gauge. (b) When rotated (counterclockwise), the spiral inset “grows” until (c) it eventually jams. The final orientation of the spiral inset now reflects kerf. (d) The shape of the spiral gauge is derived from an Archimedean spiral.

FIG. 26: Kerfmeter positions the gauge to over openings in the grid table. This causes the insets to drop

FIG. 27: Kerfmeter orients the prongs to match the holes in the gauge

FIG. 28: One embodiment of Kerfmeter mounted to the head of a laser cutter

FIG. 29: Alternative Embodiments of Kerfmeter Devices

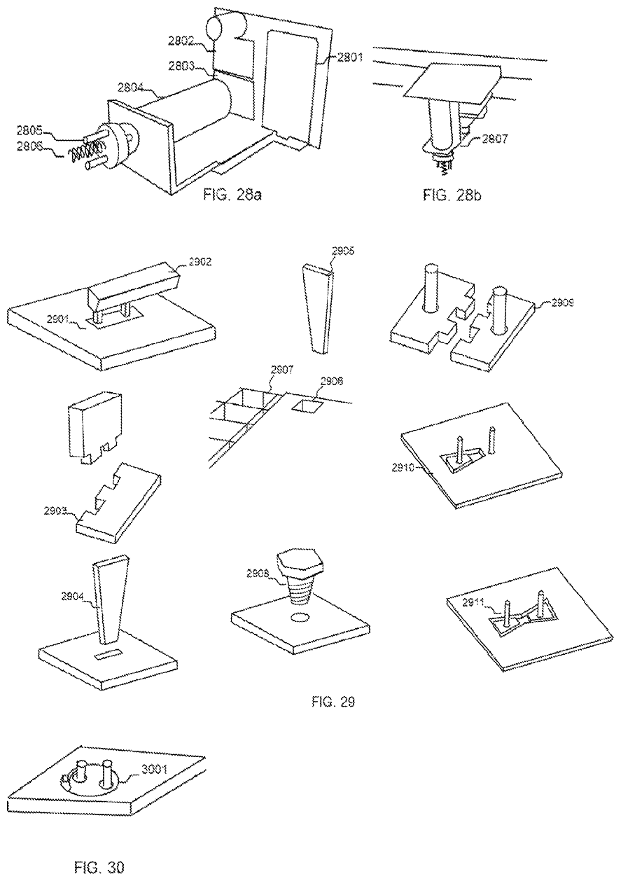

FIG. 30 Archimedean Spiral Embodiment of Kerfmeter

FIG. 31: Sequence diagram showing the communication between the modeling system, Kerfmeter's software server, and the laser cutter's API.

FIG. 32: (a) Rotating the spiral inset past 180° causes it to disengage from the surrounding material, thus break. (b) This is because the inset is not held in place anymore by the surrounding.

FIG. 33: Kerfmeter recursively computes the angle to compute kerf

FIG. 34: (a) The force that holds a joint together is defined by the area of the contact (b) The torque required to tighten the spiral swatch is defined by the material thickness L, the angle of rotation

FIG. 35: The torque of Kerfmeters' motor increases linearly with the length of the PWM duty cycle.

FIG. 36: Flowchart of Kerfmeter measuring Kerf in different positions

FIG. 37: Open-loop laser cutting multiple times.

FIG. 38: Flowchart of calibration routine for optimizing settings for multi-pass cutting for improved repeatability (open-loop method)

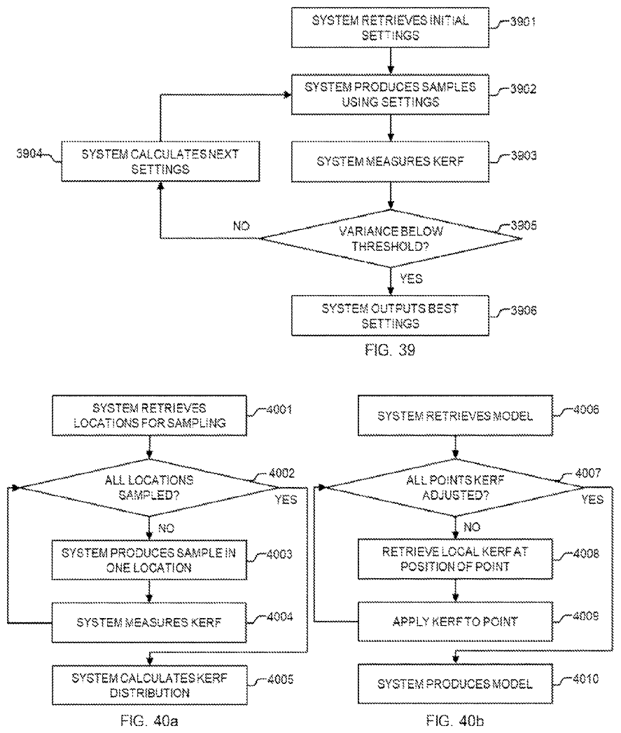

FIG. 39: Flowchart of calibration routine for optimizing settings for multi-pass cutting for improved repeatability (closed-loop method)

FIG. 40: Flowchart of calibration process

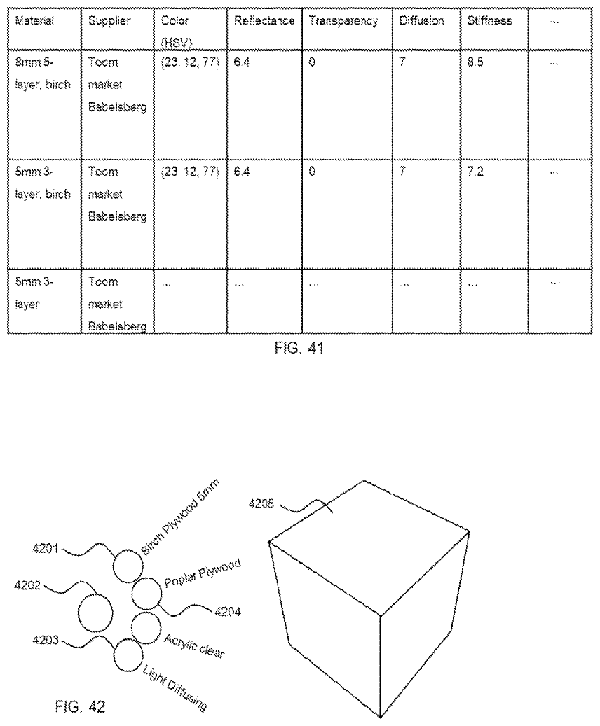

FIG. 41: Example table with feature vectors describing materials

FIG. 42: a user interface that allows users to pick a class of materials

FIG. 43: Workflow early possession

FIG. 44: Workflow scanning sheet in laser cutter

FIG. 45 Marker with additional reverse look-up ID

FIG. 46: Assigning sheets during the export (material mapping).

FIG. 47: Direct manipulation nesting interface

1. An apparatus comprising:
a sensor that detects changes in a workpiece in response to a subtractive fabrication machine operating on the workpiece.

2-23. (canceled)
